(19) United States
(12) Patent Application Publication
(10) Pub. No.: US 2026/0331886 A1
(43) Pub. Date: Oct. 22, 2026

(54) UTILITY ENCLOSURE AND COVER ASSEMBLY

(71) Applicant: Root Plastics, LLC, Loveland, OH (US)

(72) Inventors: Christopher McCall, Loveland, OH (US); Brad Robillard, Dayton, OH (US); Patrick Harris, Downers Grove, IL (US); Michael Allen Tadych, Mora, MN (US); Jeff Klawiter, Jenison, MI (US)

(73) Assignee: Root Plastics, LLC, Loveland, OH (US)

(21) Appl. No.: 19/648,672

(22) Filed: Apr. 15, 2026

Related U.S. Application Data
(60) Provisional application No. 63/789,494, filed on Apr. 16, 2025.

(51) Int. Cl. H02G 3/08; H02G 3/12

(52) U.S. Cl. CPC H02G 3/081; H02G 3/12

(57) ABSTRACT

A utility enclosure assembly includes an enclosure and a cover and is configured to be installed underground with a top surface of the cover proximate grade level. The enclosure has an inner surface having a ledge proximate a top of the enclosure, where the ledge supports the cover when the cover is engaged with the enclosure. The enclosure and the cover are constructed of high-density polyethylene and optionally calcium carbonate. The utility enclosure assembly is compliant with the Tier 22 requirements for underground utility enclosures, as determined according to the standard test methods in ANSI/SCTE 77 (2023). The cover is a two-piece cover with a bottom piece, a top piece, and a plurality of ribs extending vertically between the two pieces.

### CROSS-REFERENCE TO RELATED APPLICATION

This application claims the benefit of priority of U.S. Provisional Patent Application No. 63/789,494, filed on Apr. 16, 2025, and entitled “Utility Enclosure and Cover Assembly,” the entire contents of which are incorporated by reference herein.

### TECHNICAL FIELD

Principles and embodiments of the present disclosure relate generally to underground utility enclosures and covers for containing utility equipment.

### BACKGROUND

The current trend is to run utilities, such as but not limited to electrical lines, power lines, fiber optic communication cables, security lines, water lines, gas lines, and/or other utilities, underground. Utility lines can be joined to extend branches or split to provide multiple lines of service from a single or multiple incoming lines. Equipment for combining utility lines, splitting utility lines, or otherwise managing utility lines are often contained within underground utility enclosures, which are installed in the ground such that an opening to the underground utility enclosure is flush with the surface grade. Certain underground utility enclosures are installed in locations requiring the enclosure to bear weight, such as from pedestrian or periodic vehicular traffic.

### SUMMARY

The present disclosure is directed to underground utility enclosures and covers therefor that are compliant with ANSI/SCTE 77 (2023) Tier 22 requirements for underground utility enclosures. The utility enclosure assemblies disclosed herein include an enclosure and a cover. According to one aspect disclosed herein, a utility enclosure assembly comprises an enclosure and a cover, and the utility enclosure assembly is configured to be installed underground with a top surface of the cover proximate grade level. The enclosure may comprise an inner surface having a ledge proximate a top of the enclosure, where the ledge supports the cover when the cover is engaged with the enclosure. The enclosure and the cover are constructed of high-density polyethylene and optionally calcium carbonate. The utility enclosure assembly is compliant with the Tier 22 requirements for underground utility enclosures, as determined according to the standard test methods in ANSI/SCTE 77 (2023).

According to one or more other aspects disclosed herein, a cover for an underground utility enclosure may comprise a top piece and a bottom piece, wherein: the top piece may have a plurality of first ribs and the bottom piece may have a plurality of triangular gussets; and when the top piece and the bottom piece are assembled together to form the cover, the plurality of first ribs may engage with the plurality of triangular gussets to redirect a portion of downward forces exerted on the cover outward towards a sidewall of the cover.

These and other aspects, advantages, and salient features will become apparent from the following detailed description, the accompanying drawings, and the appended claims.

### BRIEF DESCRIPTION OF THE DRAWINGS

FIG. 1 is a perspective view of a utility enclosure assembly, according to embodiments shown and described herein;

FIG. 2 is a perspective view of an enclosure of the utility enclosure assembly of FIG. 1, according to embodiments shown and described herein;

FIG. 3 is a perspective view of another embodiment of an enclosure of the utility enclosure assembly of FIG. 1, according to embodiments shown and described herein;

FIG. 4 is a front view of the enclosure of FIG. 2, according to embodiments shown and described herein;

FIG. 5 is a side view of the enclosure of FIG. 2, according to embodiments shown and described herein;

FIG. 6 is a rear perspective view of one half of the enclosure of FIG. 3, according to embodiments shown and described herein;

FIG. 7 is a top view of the enclosure of FIG. 2, according to embodiments shown and described herein;

FIG. 8 is an exploded perspective view of a cover of the utility enclosure assembly of FIG. 1, according to embodiments shown and described herein;

FIG. 9 is an exploded perspective view of another embodiment of a cover for the utility enclosure assembly of FIG. 1, according to embodiments shown and described herein;

FIG. 10 is a bottom perspective view of a top piece of the cover of FIG. 8, according to embodiments shown and described herein;

FIG. 11 is a cross-sectional view of the top piece of FIG. 10 taken along reference line 11-11 in FIGS. 10 and 13, according to embodiments shown and described herein;

FIG. 12 is a cross-sectional view of the top piece of FIG. 10 taken along reference line 12-12 in FIGS. 10 and 13, according to embodiments shown and described herein;

FIG. 13 is a bottom view of a top piece of the cover of FIG. 9, according to embodiments shown and described herein;

FIG. 14 is a top view of the top piece of FIG. 13, according to embodiments shown and described herein;

FIG. 15 is a top perspective view of a bottom piece of the cover of FIG. 9, according to embodiments shown and described herein;

FIG. 16 is a cross-sectional view of the bottom piece of FIG. 15 taken along reference line 16-16 in FIG. 18, according to embodiments shown and described herein;

FIG. 17 is a cross-sectional view of the bottom piece of FIG. 15 taken along reference line 17-17 in FIG. 18, according to embodiments shown and described herein;

FIG. 18 is a top view of the bottom piece of FIG. 15, according to embodiments shown and described herein;

FIG. 19 is a bottom view of the bottom piece of FIG. 15, according to embodiments shown and described herein;

FIG. 20 is a bottom perspective view of a top piece of the cover of FIG. 9, according to embodiments shown and described herein;

FIG. 21 is a side view of the top piece of FIG. 20, according to embodiments shown and described herein;

FIG. 22 is a magnified perspective view of a portion of the top piece of FIG. 20, according to embodiments shown and described herein;

FIG. 23 is a magnified portion of the side view of the top piece of FIG. 21, according to embodiments shown and described herein;

FIG. 24 is a magnified perspective view of the bottom piece of FIG. 15, according to embodiments shown and described herein;

FIG. 25 is a magnified portion of the cross-sectional view of the bottom piece of the cover of FIG. 17, according to embodiments shown and described herein;

FIG. 26 is a cross-sectional view of the cover of FIGS. 9 and 13-25 showing interaction between a first rib of a top piece and a triangular gusset of a bottom piece of the cover of FIGS. 9 and 13-25, according to embodiments shown and described herein;

FIG. 27 is a magnified portion of the cross-sectional view of the cover of FIG. 26, according to embodiments shown and described herein;

FIG. 28 is a perspective view of a name identification puck and puck attachment fitting of the cover of FIG. 9, according to embodiments shown and described herein;

FIG. 29 is a top view of the puck attachment fitting in FIG. 28, according to embodiments shown and described herein;

FIG. 30 is a side view of the name identification puck of FIG. 28, according to embodiments shown and described herein;

FIG. 31 is a bottom perspective view of the name identification puck of FIG. 28, according to embodiments shown and described herein;

FIG. 32 is a top view of a nut plate for attaching the cover to the enclosure for the utility enclosure assembly of FIG. 1, according to embodiments shown and described herein;

FIG. 33 schematically depicts a side view of an attachment bolt for attaching the cover to the enclosure for the utility enclosure assembly of FIG. 1, according to embodiments shown and described herein;

FIG. 34 schematically depicts a cross-sectional view of attachment of the cover to the enclosure using the attachment bolt of FIG. 33, according to embodiments shown and described herein;

FIG. 35 schematically depicts a cross-sectional view of detachment of the attachment bolt from a nut plate while retaining the attachment bolt in the cover, according to embodiments shown and described herein; and

FIG. 36 is a front perspective view of another embodiment of an enclosure assembly, according to embodiments shown and described herein.

### DETAILED DESCRIPTION

Reference will now be made in detail to embodiments of the utility enclosures and covers of the present disclosure. In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified.

As previously discussed, equipment for combining utility lines, splitting utility lines, or otherwise managing utility lines are often contained within underground utility enclosures, which are installed in the ground such that an opening to the underground utility enclosure is flush with the surface grade. Certain underground utility enclosures are installed in locations requiring the enclosure to bear weight, such as from pedestrian or periodic vehicular traffic. These underground utility enclosures must meet the requirements of ANSI/SCTE 77 (2023) Tier 22 requirements for underground utility enclosures, which includes supporting a vertical force of at least 22,500 pounds of force, among other requirements.

Existing underground utility enclosures and covers meet this standard by incorporating rigid materials, such as concrete, steel, or other materials with high tensile strength. However, these materials can be expensive and can add substantial weight to the enclosures and covers. In some cases, support bars or support rods are incorporated into the enclosures and or lids, which greatly increase the cost and complexity of the enclosures and covers. In other instances, the polymer compositions with reinforcing fibers are used to increase the tensile strength of the materials in order to comply with the Tier 22 requirements. However, incorporating reinforcing fibers is costly and complicates the process for making the enclosures and/or covers. Thus, an ongoing need exists for underground utility enclosures and covers that are lighter, cheaper, and easier to handle and install, while also complying with the Tier 22 requirements, as determined by the standard test methods in ANSI/SCTE 77 (2023).

The present disclosure is directed to utility enclosure assemblies comprising an enclosure and a cover, where the utility enclosure assemblies are compliant with ANSI/SCTE 77 (2023) Tier 22 requirements for underground utility enclosures. The enclosure and cover are injection molded from a material comprising, consisting of, or consisting essentially of HDPE and, optionally, calcium carbonate, as an additive.

### Utility Enclosure Assembly

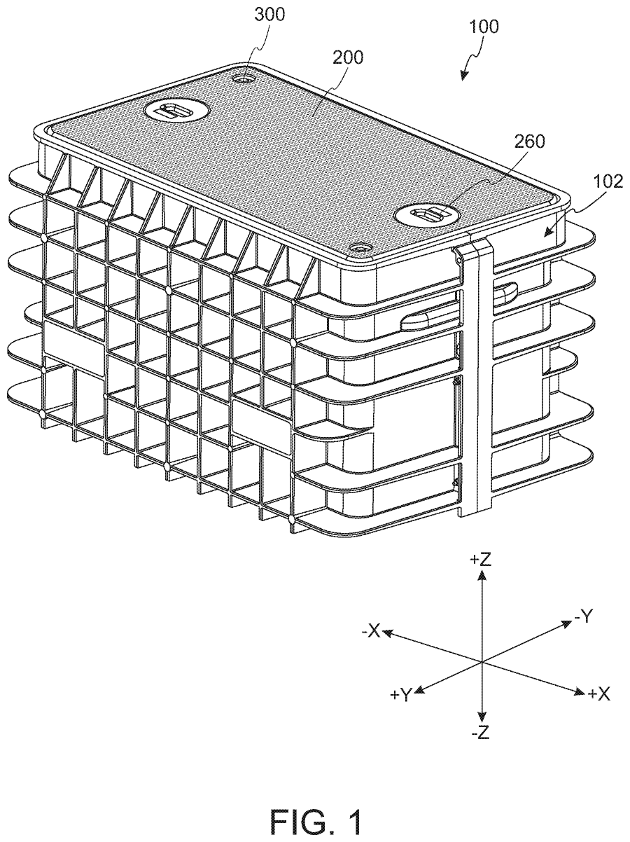

Referring now to FIG. 1, the utility enclosure assembly 100 of the present disclosure is designed for installation below grade so that the top of the utility enclosure assembly 100 is at grade level and the enclosure extends downward below the ground. The utility enclosure assembly 100 may include an enclosure 102, a cover 200, and an attachment mechanism 300 for attaching the cover 200 to the enclosure 102. The utility enclosure assembly 100 may further include one or more name identification pucks 260 (i.e., name ID puck 260) coupled to the cover 200. The utility enclosure assembly 100 may be compliant with ANSI/SCTE 77 (2023) Tier 22 requirements for underground utility enclosures.

### Enclosure

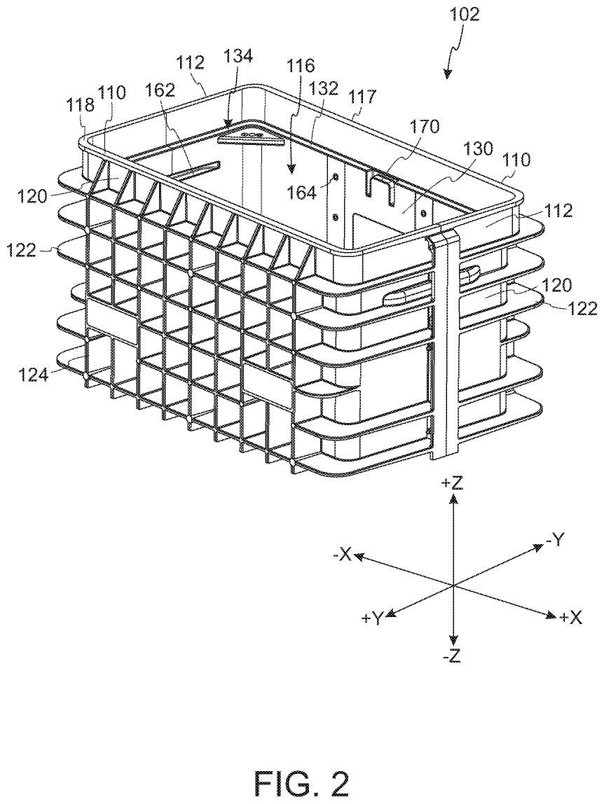

Referring now to FIG. 2, the enclosure 102 may include two side walls 110 and two end walls 112 rigidly attached to each other to form a four-sided square or rectangular box. When the enclosure is rectangular, the two side walls 110 may be longer than the two end walls 112. When the enclosure 102 is square, the side walls 110 may be the walls having the vertical ribs 124 on the outer surface 120, and the end walls 112 may have only the horizontal ribs 122 on the outer surface 120. The enclosure 102 may be an open bottom enclosure. The enclosure 102 may have a bottom opening 114 (FIG. 7) and a top opening 116. The bottom opening 114 may enable utility cables (not shown), such as but not limited to fiber optic cables, electrical lines, or other utilities, to be introduced into an internal volume of the enclosure 102 through the bottom opening 114. Referring again to FIG. 2, the top opening 116 may allow for access to the internal volume of the enclosure 102 from the top, such as to install one or more pieces of equipment in the utility enclosure assembly 100. The enclosure 102 may include a flange 118 at the top of the enclosure 102, wherein the flange 118 circumscribes the top opening 116.

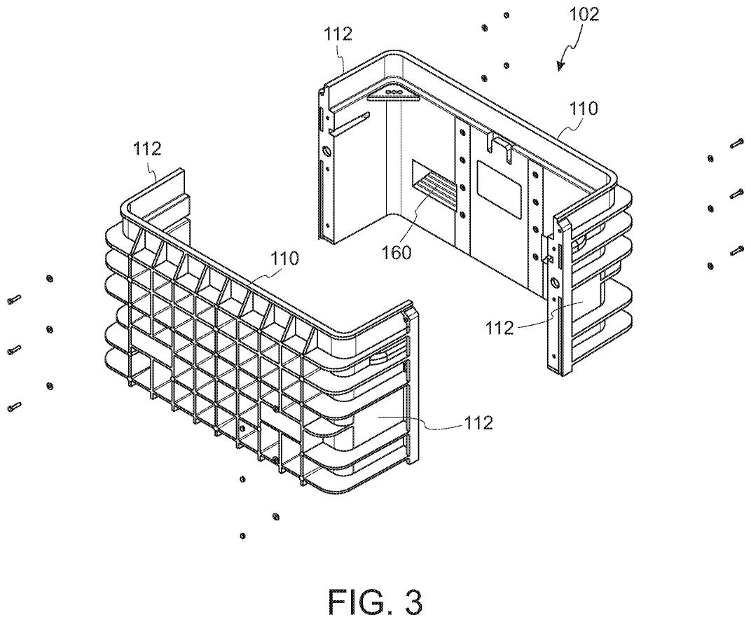

In embodiments, the enclosure 102 may be formed as a unitary piece. Referring now to FIG. 3, in embodiments, the enclosure 102 may comprise two pieces that are fastened together rigidly to form the four-sided enclosure 102. The two pieces of the enclosure 102 may be fastened together with bolts, screws, clips, welds, rivets, adhesives, or any other suitable means of attaching the two halves of the enclosure 102 together. The two halves of the enclosure 102 may be fastened together at the side walls 110 or at the end walls 112.

Referring again to FIG. 2, the side walls 110 and end walls 112 of the enclosure 102 may each have an outer surface 120, which faces outward away from the internal cavity of the enclosure 102. The outer surfaces 120 may have horizontal ribs 122, vertical ribs 124, or both, which may provide additional strength and stability to the side walls 110 and/or end walls 112. In embodiments, the horizontal ribs 122 may extend all the way around the enclosure 102. In embodiments, one or more of the horizontal ribs 122 may extend around at least about 90%, or even at least about 95% of the entire periphery of the outer surfaces 120 of the enclosure 102. In embodiments, at least one of the horizontal ribs 122 may extend across each of the side walls 110, but not across the end walls 112. The area of the end walls 112 not having the horizontal ribs 122 or vertical ribs 124 may allow for one or more holes to be cut and/or drilled in the end wall 112 for passing a utility line, pipe, cable, or combinations thereof through the end wall 112 and into the internal volume of the enclosure 102.

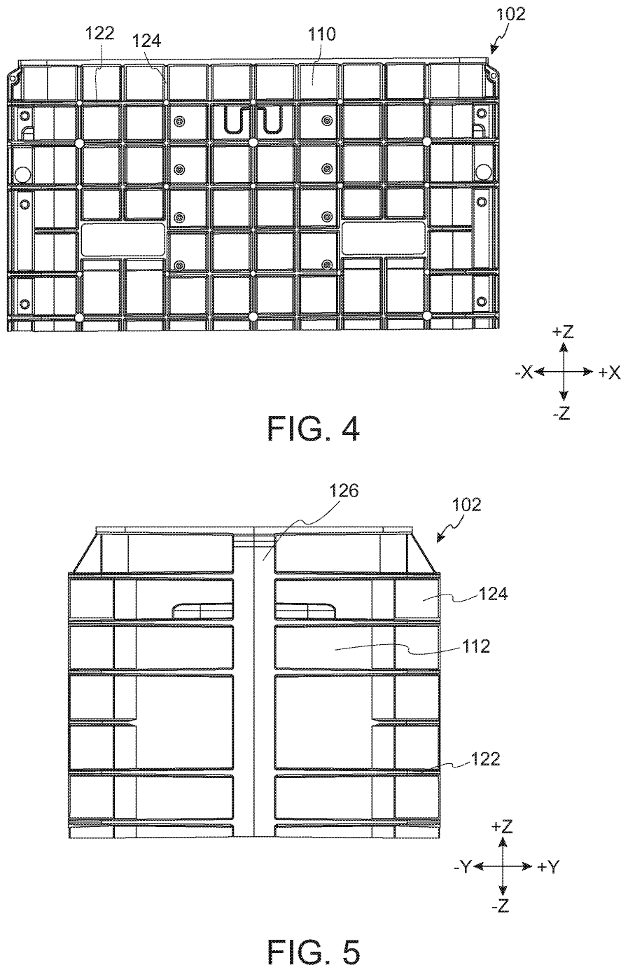

The outer surfaces 120 may further include the plurality of vertical ribs 124, which may extend from the bottom of the enclosure 102 to the flange 118 at the top 117 of the enclosure 102. In embodiments, the vertical ribs 124 may extend all the way to the top 117 of the enclosure 102. In embodiments, the vertical ribs 124 may extend at least 90%, at least 95%, or at least 98% of the vertical distance between the bottom of the enclosure 102 to the flange 118 around the top 117 of the enclosure 102. In embodiments, the vertical ribs 124 may taper in size in a region proximate to the top 117 of the enclosure 102. The vertical ribs 124 may intersect the horizontal ribs 122 to form a lattice. In embodiments, the side walls 110 may include the vertical ribs 124, where the vertical ribs 124 intersect the horizontal ribs 122 to form the lattice on the outer surface 120 of the side walls 110. FIG. 4 shows a front view of one of the side walls 110 having the horizontal ribs 122 and vertical ribs 124.

Referring now to FIG. 5, a straight-on view of an end wall 112 of the enclosure 102 is shown. The end walls 112 may have the horizontal ribs 122 extending laterally (i.e., in the +/−Y direction of the coordinate axis in FIG. 5) across the outer surface 120 of the end walls 112. In embodiments, the end walls 112 may not have the vertical ribs 124, such that the lattice is only formed on the side walls 110. In embodiments, the end walls 112 may have at least one region that does not have horizontal ribs 122 or vertical ribs 124, which may provide a location for drilling one or more holes in the end wall 112 for passing an incoming or outgoing utility line, pipe, cable, or combinations thereof through the end wall 112. When the enclosure 102 comprises two separate pieces fastened together, as shown in FIG. 3, the end walls 112 may have thickened region 126 for facilitating attachment of the two halves. This thickened region 126 may provide additional vertical support, making the presence of additional vertical ribs 124 on the end walls 112 unnecessary. In embodiments, the end walls 112 may also have the vertical ribs 124, which may intersect the horizontal ribs 122 to form a lattice on the end walls 112.

Referring again to FIG. 2, the enclosure 102 may have an inner surface 130 facing inward to define the interior cavity of the enclosure 102. The inner surface 130 of the enclosure 102 may comprise the inner surfaces of each of the side walls 110 and the end walls 112. The inner surface 130 may have a ledge 132 extending around the inner surface 130 of the enclosure 102. The ledge 132 may extend around at least 90%, at least 95%, or even at least 98% around the perimeter of the inner surface 130 of the enclosure 102. The ledge 132 may have an upward facing surface 134 (i.e., surface facing in a +Z direction of the coordinate axis in FIG. 2). The upward facing surface 134 may provide an abutment for supporting the cover 200 when the cover 200 is installed on the enclosure 102.

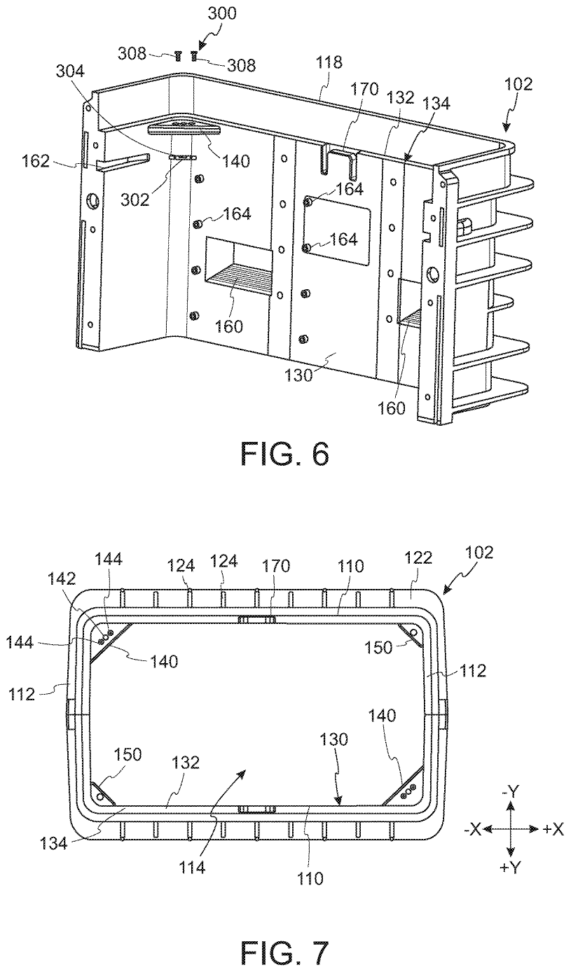

Referring now to FIGS. 6 and 7, the enclosure 102 may include a plurality of attachment flanges 140 disposed in corners of the enclosure 102. The attachment flanges 140 may be configured to secure a nut plate 302 (FIG. 6) to the enclosure 102, the nut plate 302 being used to secure and/or attach the cover 200 to the enclosure 102. FIG. 6 shows a rear perspective view of one half of the enclosure 102, and FIG. 7 shows the enclosure 102 in top view without the cover 200. In embodiments, the attachment flanges 140 may have a triangular shape with a first edge formed integral with the side wall 110, a second edge formed integral with the end wall 112, and the third edge extending between the second edge and the first edge to form a triangle. The attachment flanges 140 may have an upper surface facing in the +Z direction of the coordinate axis in FIG. 6 and a lower surface facing in the −Z direction of the coordinate axis in FIG. 6. In embodiments, the nut plates 302 may be attached to the bottom surface of the attachment flanges 140. Although shown in FIGS. 6 and 7 as having a triangular shape, the attachment flanges 140 may have any suitable shape that allows for attachment of the nut plate 302 to the attachment flange 140.

Referring to FIG. 7, each of the attachment flanges 140 may include a primary hole 142, which may be sized to receive an attachment bolt therethrough. The attachment bolt may pass through the primary hole 142 to the nut plate 302 on the other side of the attachment flange 140. The attachment flange 140 may further include two secondary holes 144 on either side of the primary hole 142. The secondary holes 144 may enable fasteners, such as but not limited to bolts, screws, rivets, pins, clips, and the like, to be used to attach the nut plate 302 to the attachment flange 140. As shown in FIG. 7, in embodiments, the enclosure 102 may have two attachment flanges 140, which may be disposed in opposing corners of the enclosure 102. In embodiments, the enclosure 102 may include four attachment flanges 140, one in each corner.

Referring to FIG. 7, in embodiments, the inner surface 130 of the enclosure 102 may include one or more tracer tape tie downs 150, which may each include a flange attached to the inner surface 130 of the enclosure 102, where the flange has a hole through it for attaching the ends of tracer tapes. Tracer tapes are used to detect the presence of underground utilities, such as buried electrical or fiber optic cables, in particular fiber optic cables, which are generally metal free and, therefore, more difficult to detect. As a result, the tracer tapes are buried along the path of the fiber or other utility conduit to enable location of the path of the fiber or other utility conduit.

Referring again to FIGS. 2 and 6, in embodiments, the inner surface 130 may have one or more foot pockets 160, which are recesses in the inner surface 130 of the enclosure 102. The foot pockets 160 may conform to OSHA standards for ladders and may provide a means for an installer to climb into and out of the enclosure 102 during servicing or installation of equipment in the enclosure 102. The foot pockets 160 may be sized to receive a human foot, such as when climbing out of the enclosure 102. In embodiments, each foot pocket 160 may include ridges disposed on an upper surface of the foot pocket 160. The ridges may provide tread to reduce or prevent the risk of a foot slipping out of the foot pocket 160 while climbing into or out of the enclosure 102. The foot pockets 160 may be disposed in the side walls 110, the end walls 112, or both. In embodiments, the foot pockets 160 may be disposed in the side walls 110 having the vertical ribs 124 on the outer surface 120. The foot pockets 160 may be disposed in only one of the side walls 110 or in both side walls 110.

Referring again to FIGS. 2 and 6, the enclosure 102 may have a plurality of hand holds 162 recessed into the inner surface 130. The hand holds 162 may provide a grip for handling the enclosure 102, such as during shipping, installation, or removal of the enclosure 102. The hand holds 162 may be formed in the side walls 110, the end walls 112, or both. In embodiments, the hand holds 162 are formed in the end walls 112, and the foot pockets 160 are formed in the side walls 110.

The enclosure 102 may further include a plurality of mounting holes 164 recessed into the inner surface 130 of the side walls 110, end walls 112, or both. The mounting holes 164 may allow for mounting of equipment directly to the side walls 110, end walls 112, or both. In embodiments, the mounting holes 164 may the threaded.

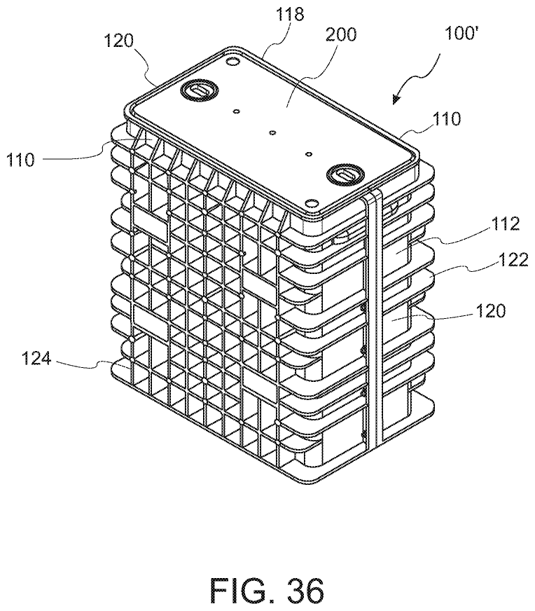

In embodiments, the inner surface 130 of the side walls 110 may include a U-shaped recess 170 for supporting a cover support bar (not shown). In embodiments, the utility enclosure assembly 100 does not have a cover support bar. The enclosure 102 may be provided in different sizes and depths. Referring now to FIG. 36, another embodiment of the enclosure 102 is schematically depicted. The enclosure 102 of FIG. 36 is deeper than the enclosure 102 in FIG. 1 but includes all the same features, such as but not limited to the side walls 110, end walls 112, top opening 116, outer surface 120, horizontal ribs 122, vertical ribs 124, inner surface 130, ledge 132, triangular attachment flange 140, foot pockets 160, hand holds 162, mounting holes 164, and other features.

The enclosure 102 may be constructed of a polymer material. In embodiments, the enclosure 102 may be constructed of high-density polyethylene (HDPE). The polymer may include HDPE and calcium carbonate as a structural additive. The polymer for the enclosure 102 may further include pigments and/or colorants, UV inhibitors, lubricants, processing aids, or any combinations of these. The pigments and/or colorants may be added to the polymer masterbatch to provide color to the enclosure 102. The UV inhibitors may be included in the polymer masterbatch to reduce or prevent UV radiation from ambient light from degrading the polymer. The polymer masterbatch for making the enclosures 102 may further include processing aids, such as but not limited to lubricants, rheology modifiers, blowing agents, etc., which may be added to the masterbatch to facilitate injection molding of the polymer material to form the enclosures 102.

In embodiments, the enclosures 102 may be substantially free of fiber reinforcing materials, such as but not limited to glass fibers, carbon fibers, SiC fibers, or any other fibers added to the polymer (e.g., HDPE) to impart additional tensile strength. The enclosures 102 being substantially free of reinforcing fibers may have less than 0.1 wt. % of reinforcing fibers per unit weight of the polymer material making up the enclosures 102. In embodiments, the enclosures 102 may be made from a polymer material comprising, consisting of, or consisting essentially of HDPE, pigments and/or colorants, optionally a UV inhibitor, and optionally one or more processing aids selected from lubricants, rheology modifiers, blowing agents, and combinations thereof. In embodiments, the enclosures 102 may be made from a polymer material comprising, consisting of, or consisting essentially of HDPE, calcium carbonate, pigments/colorants, optionally a UV inhibitor, and optionally one or more processing aids selected from lubricants, rheology modifiers, and combinations thereof.

The enclosures 102 may be formed through injection molding according to methods known in the art. In embodiments, the enclosure 102 may be formed through structural foam injection molding. In embodiments, the enclosures 102 may be injection molded as a single enclosure 102. In embodiments, the enclosures 102 may be made by injection molding two or more than two pieces of the enclosure 102 and then attaching the two or more pieces of the enclosure 102 together. The two or more pieces of the enclosure 102 may be attached together using welds, fasteners (e.g., screws, bolts, clips, clamps, brackets, etc.), adhesives, interlocking tabs, or combinations thereof. In embodiments, the enclosure 102 may include two halves that are attached together using screws and/or bolts. The enclosure 102 does not include any support structure made from a material different from the polymer material used to injection mold the enclosure 102. In embodiments, the enclosure 102 does not include any support structure made from a metal, wood, concrete, polymer concrete, or any other material having a greater strength (bend strength, tensile strength, etc.) compared to the polymer composition of the enclosure 102.

### Cover

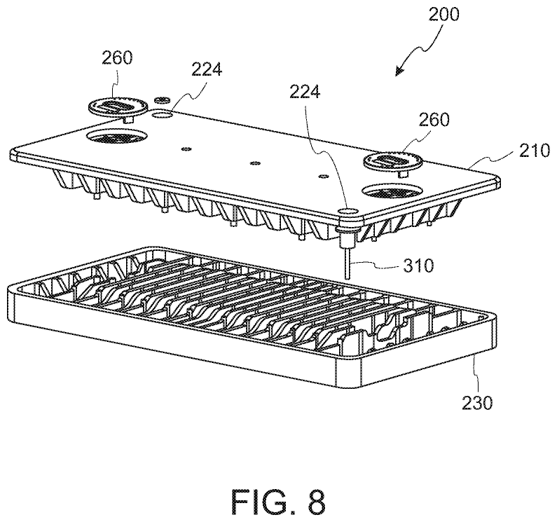

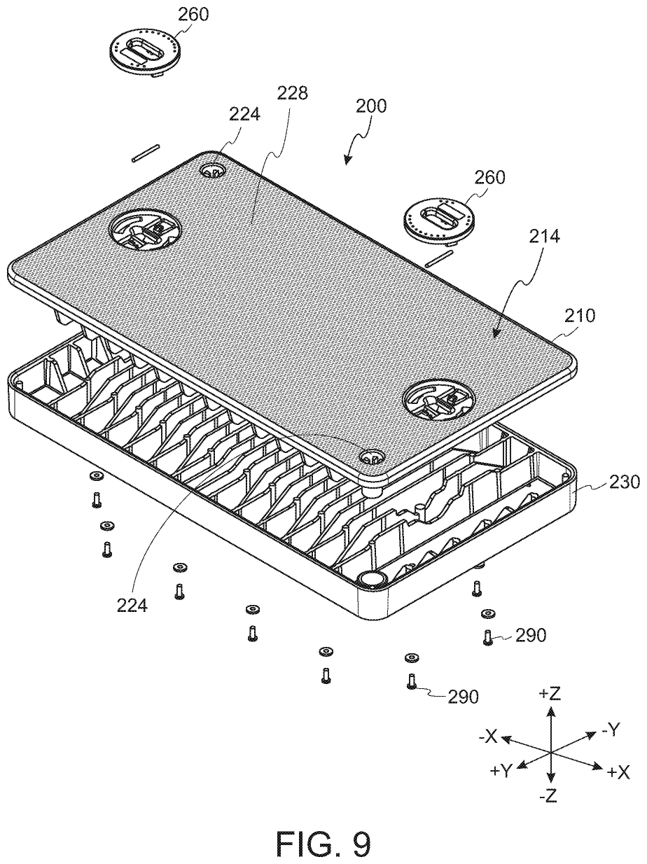

Referring now to FIG. 8, one embodiment of the cover 200 is shown in an exploded perspective view. The cover 200 is an assembly comprising a top piece 210 and a bottom piece 230, which are coupled together to form the cover 200. The cover 200 may further include one or more name ID pucks 260 attachable to the top piece 210 of the cover 200. Referring now to FIG. 9, another embodiment of the cover 200 is shown in an exploded perspective view. As shown in FIG. 9, in embodiments, the cover 200 may further include a tread pattern 228 on the top surface of the cover 200. As shown in FIG. 9, in embodiments, the top piece 210 and the bottom piece 230 may be coupled together using one or more fasteners 290, such as screws and/or bolts. Although shown as being coupled together using fasteners 290, it is understood that the top piece 210 and bottom piece 230 of the cover 200 may be coupled together with welds, adhesives, interlocking tabs, heat stake welds, other fastening methods, or combinations thereof.

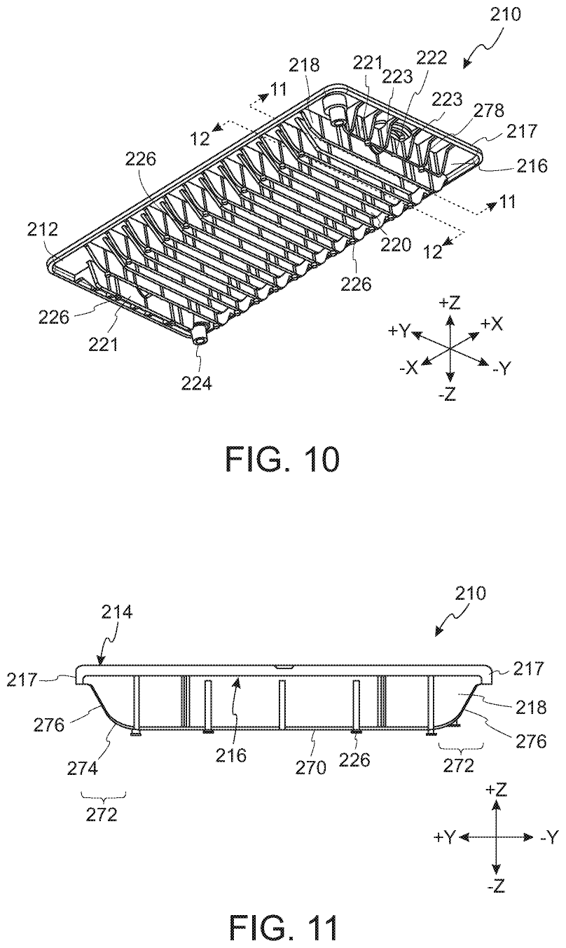

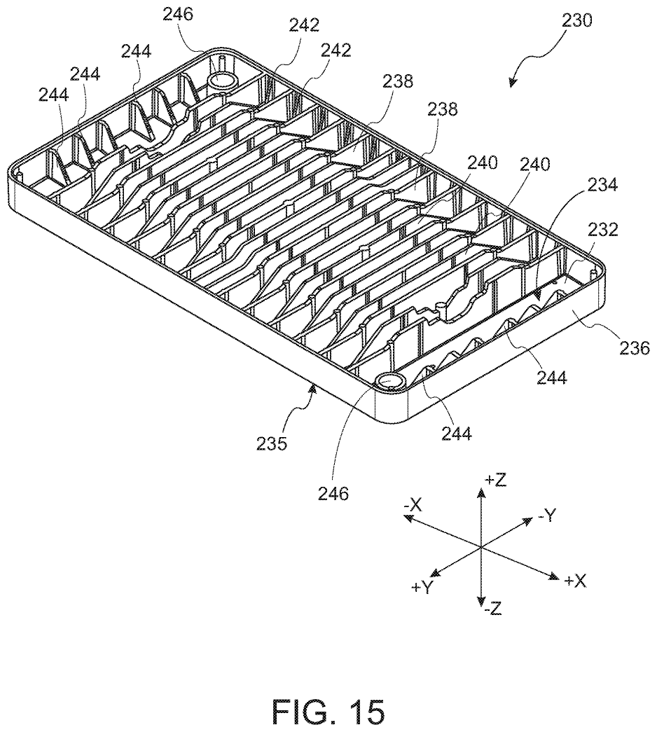

Referring now to FIGS. 10 and 11, the top piece 210 may comprise a plate 212 having a top surface 214 and the bottom surface 216. The top surface 214 may be the top of the cover 200. The top piece 210 may have a rim 217 surrounding the perimeter of the plate 212 and extending downward (i.e., in the −Z direction of the coordinate axis in FIG. 10) from the plate 212. The top piece 210 may a plurality of first ribs 218 and a plurality of second ribs 220 extending downward (i.e., in the −Z direction of the coordinate axis of FIG. 10) from the bottom surface 216 of the plate 212. The first ribs 218 and the second ribs 220 may alternate along the length of the plate 212. FIG. 11 shows a cross-sectional view of the top piece 210 of the cover 200 taken along reference line 11-11 in FIGS. 10 and 13. Referring to FIG. 11, the first ribs 218 may extend horizontally (i.e., in the +/−Y direction of the coordinate axis of FIG. 11) from the rim 217 on one side of the top piece 210 to the rim 217 on the other side of the top piece 210. The first ribs 218 may have a flat section 270 in the middle. When the cover 200 is assembled, the flat sections 270 of the first ribs 218 may contact the top surface 234 (FIGS. 15-17) of the bottom piece 230 (FIGS. 15-17) or may be spaced apart from the top surface 234 of the bottom piece 230.

Referring again to FIG. 11, on the horizontal ends of the first ribs 218, the first ribs 218 have a tapered section 272 that tapers from the flat section 270 towards the rim 217. The tapered section 272 may have a rounded corner 274 and an interaction surface 276. The rounded corner 274 has a radius of curvature and transitions the bottom edge of the first ribs 218 from the flat section 270 to the interaction surface 276. The interaction surface 276 is an angled surface extending from the rounded corner 274 to the rim 217. The interaction surface 276 may be tangent to rounded corner 274. As will be discussed further herein, the interaction surface 276 interacts with a corresponding triangular-shaped gusset on the bottom piece 230 of the cover to direct downward forces on the first ribs 218 in a direction horizontally outward direction (i.e., in the +/−Y direction of the coordinate axis in FIG. 11) toward the sidewall 236 (FIG. 15) of the bottom piece 230 (FIG. 15).

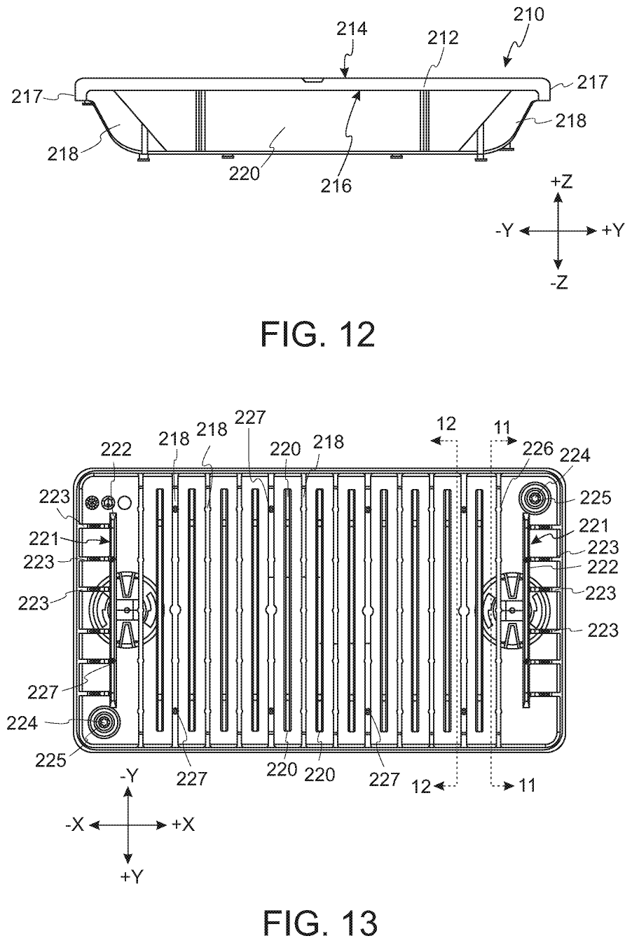

Referring now to FIG. 12, the second ribs 220 may extend only part way across the plate 212 of the top piece 210. FIG. 12 shows a cross-sectional view of the top piece 210 of the cover 200 taken along reference line 12-12 in FIGS. 10 and 13. The second ribs 220 may have a trapezoidal shape with a top edge integrally formed with the plate 212, a bottom edge facing downward (−Z direction), and two angled ends extending between the top edge and the bottom edge. The points at either end of the top edge of the second ribs 220 may be spaced apart from the rim 217 of the top piece 210. The second ribs 220 may be centered on the width of the cover 200. When the cover 200 is assembled, the first ribs 218 and second ribs 220 may contact the top surface 234 of the bottom piece 230 or may be spaced apart from the top surface 234 of the bottom piece 230. The second ribs 220 may be included to further stiffen the middle portions of the top piece 210 of the cover 200. In FIG. 12, one of the first ribs 218 is shown in the background behind the second rib 220. In embodiments, each of the second ribs 220 may be disposed midway between two of the first ribs 218 on either side of each second rib 220.

Referring again to FIG. 10, the top piece 210 may also include end ribs 221 at either end of the top piece 210. The end ribs 221 may have a main rib 222 parallel to the first ribs 218 and second ribs 220 and a plurality of triangular flanges 223 extending outward from the main rib 222 towards the rim 217 of the top piece 210. The triangular flanges 223 may have a maximum height proximate the main rib 222 and decrease in height towards the rim 217. Each of the triangular flanges 223 may have an interacting surface 278 (i.e., the angled surface) that engages with a corresponding end gusset 244 on the bottom piece 230 (see FIG. 15) to redirect downward forces in a horizontal direction (i.e., the +/−X direction of the coordinate axis in FIG. 10) towards the sidewall 236 of the bottom piece 230 (FIG. 15).

Referring to FIGS. 8-10, 13, and 14, the top piece 210 may have a plurality of bolt holes 224 extending through the top piece 210. As shown in FIG. 8, the bolt holes 224 may receive the attachment bolt 310 therethrough when attaching the cover 200 to the enclosure 102. Referring again to FIG. 13, in embodiments, the top piece 210 may include a plurality of drainage holes 225 surrounding each of the bolt holes 224. The drainage holes 225 may allow water or other liquids to drain through the interface between the top piece 210 and the attachment bolt 310 instead of collecting in the wells for the attachment bolts 310. This may prevent freeze damage to the bolt holes 224.

Referring to FIGS. 10 and 11, in embodiments, the top piece 210 may further include a plurality of ejector pins 226 coupled to one or more of the first ribs 218. The ejector pins 226 may extend downward (i.e., in the −Z direction of the coordinate axis in FIG. 11) from the first ribs 218. The ejector pins 226 may be used to attach the top piece 210 and the bottom piece 230 to produce the cover 200. In embodiments, the top piece 210 may not have the ejector pins 226. Referring to FIG. 13, in embodiments, the top piece 210 may have a plurality of threaded holes 227, which may be configured to receive the fasteners 290 (FIG. 9) for coupling the bottom piece 230 to the top piece 210. In embodiments, the threaded holes 227 may be molded into the first ribs 218, the end ribs 221, or both of the top piece 210.

Referring now to FIGS. 15-19, the bottom piece 230 may comprise a bottom plate 232 having a top surface 234 and a bottom surface 235. The bottom surface 235 may be the bottom of the cover 200. The bottom piece 230 may have a sidewall 236 surrounding the perimeter of the bottom plate 232 and extending upward (i.e., in the +Z direction of the coordinate axis in FIG. 15) from the bottom plate 232. The sidewall 236 may be configured to engage with the rim 217 of the top piece 210 to enclose the ribs (first ribs 218, second ribs 220, end ribs 221, third ribs 238, fourth ribs 240, triangular gussets 242, and end gussets 244). The bottom piece 230 may have a plurality of third ribs 238 and a plurality of fourth ribs 240 extending upward (i.e., in the +Z direction of the coordinate axis of FIG. 15) from the top surface 234 of the bottom plate 232. The third ribs 238 and the fourth ribs 240 may alternate along the length of the bottom plate 232.

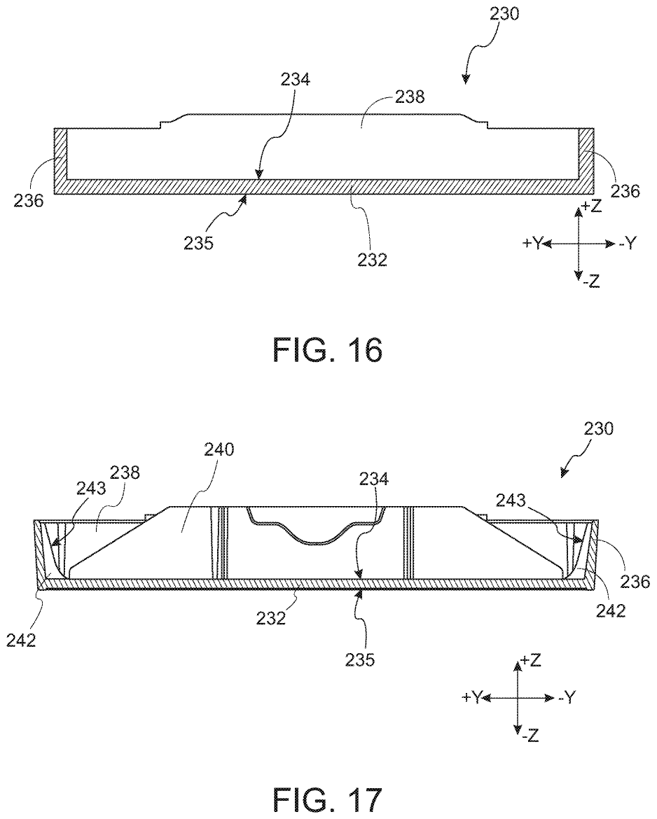

Referring now to FIG. 16, the third ribs 238 may extend from the sidewall 236 on one side of the bottom piece 230 to the sidewall 236 on the other side of the bottom piece 230. The third ribs 238 extending horizontally (i.e., in the +/−Y direction of the coordinate axis in FIG. 15) all the way across the bottom piece 230 may keep the sidewall 236 from bowing outward when downward forces are directed outward to the sidewall 236 through interaction of the interaction surfaces 276 of the first ribs 218 (top piece 210) with the angled engagement surfaces 243 of the triangular gussets 242 (bottom piece 230). When the cover 200 is assembled, the third ribs 238 may contact the bottom surface 216 of the top piece 210 or may be spaced apart from the bottom surface 216 of the top piece 210.

Referring now to FIG. 17, the fourth ribs 240 may extend only part way across the bottom plate 232 of the bottom piece 230. The fourth ribs 240 may have a trapezoidal shape with a bottom edge integrally formed with the bottom plate 232, a top edge facing upward (+Z direction), and two angled ends extending between the top edge and the bottom edge. The points at either end of the bottom edge of the fourth ribs 240 may be spaced apart from the sidewall 236 of the bottom piece 230. The fourth ribs 240 may be included on the bottom piece 230 to stiffen a middle portion of the bottom piece 230. When the cover 200 is assembled, the fourth ribs 240 may contact the bottom surface 216 of the top piece 210 or may be spaced apart from the bottom surface 216 of the top piece 210. In FIG. 17, the fourth rib 240 is shown with a third rib 238 in the background and two triangular gussets 242 in the foreground.

Referring to FIGS. 15 and 17, the bottom piece 230 may also include a plurality of triangular gussets 242, which may be attached to the sidewall 236 and the top surface 234 of the bottom plate 232. The triangular gussets 242 may be spaced apart and disposed between the third ribs 238 and fourth ribs 240. The triangular gussets 242 may have a vertical side attached to the sidewall 236, a bottom side attached to the top surface 234 of the bottom plate 232, and an angled side extending from an end of the vertical side to an end of the horizontal side. The angled side of each of the triangular gussets 242 provides an engagement surface 243. The engagement surfaces 243 of the triangular gussets 242 are configured to engage with the interaction surfaces 276 of the first ribs 218 of the top piece 210 when the top piece 210 and the bottom piece 230 are assembled together to form the cover 200. The bottom piece 230 may also have a plurality of end gussets 244 attached to the sidewall 236 at both ends of the bottom piece 230. For a rectangular cover 200, the “sides” of the top piece 210 and bottom piece 230 refer to the longer sides, and the “ends” of the top piece 210 and bottom piece 230 refer to the shorter sides.

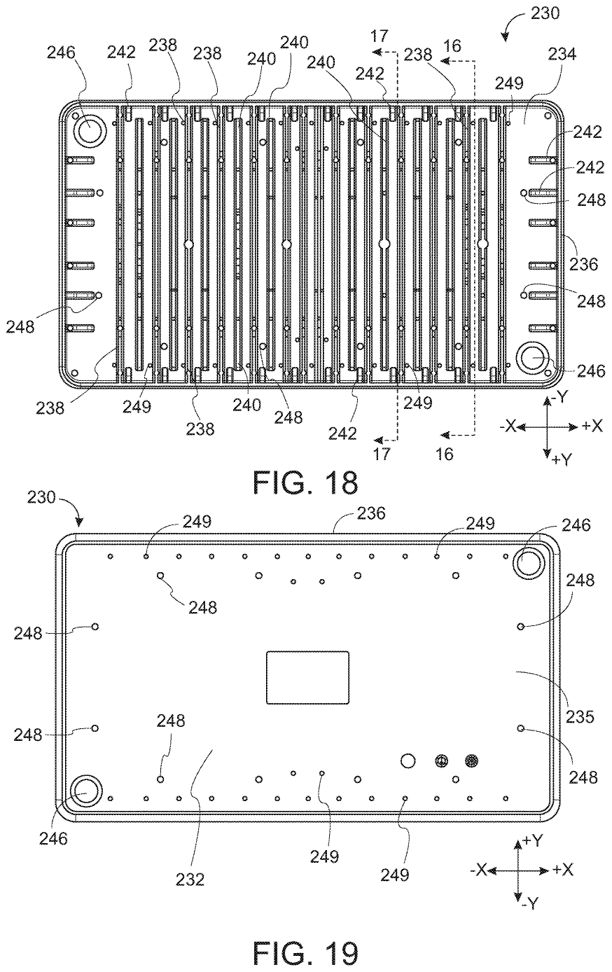

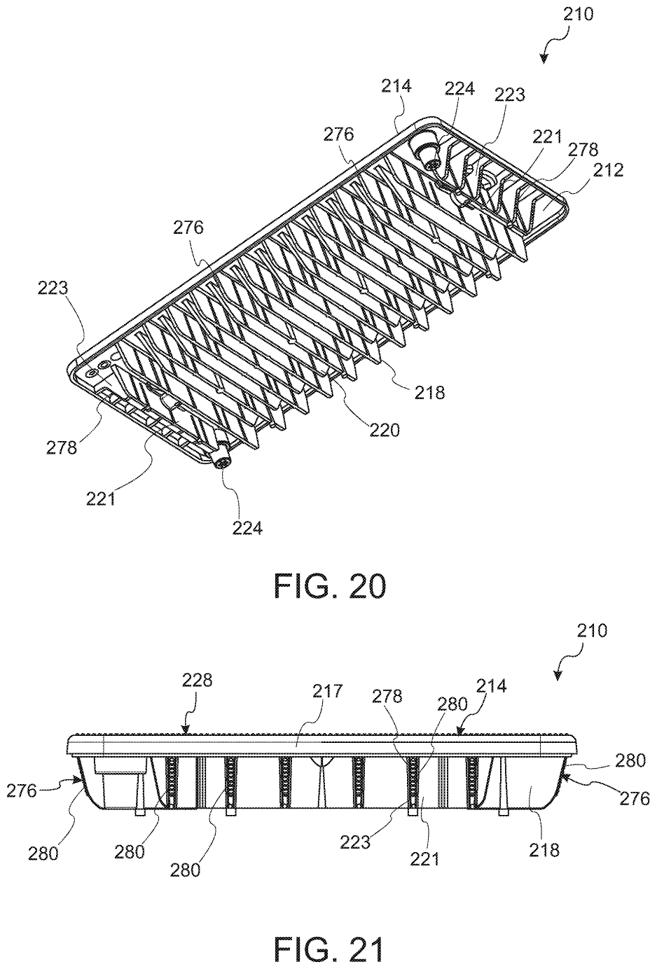

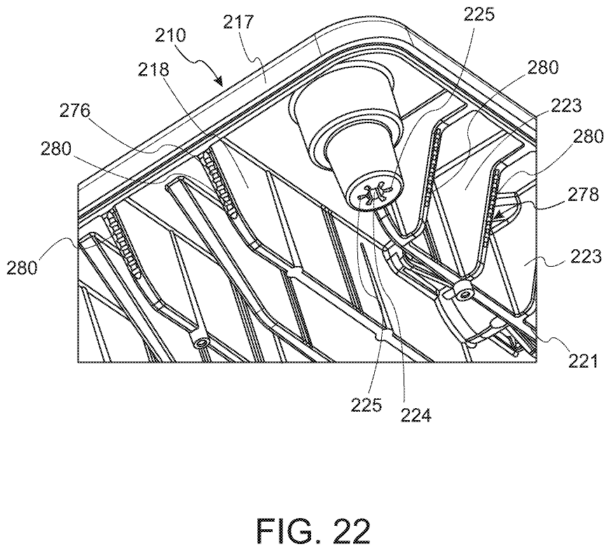

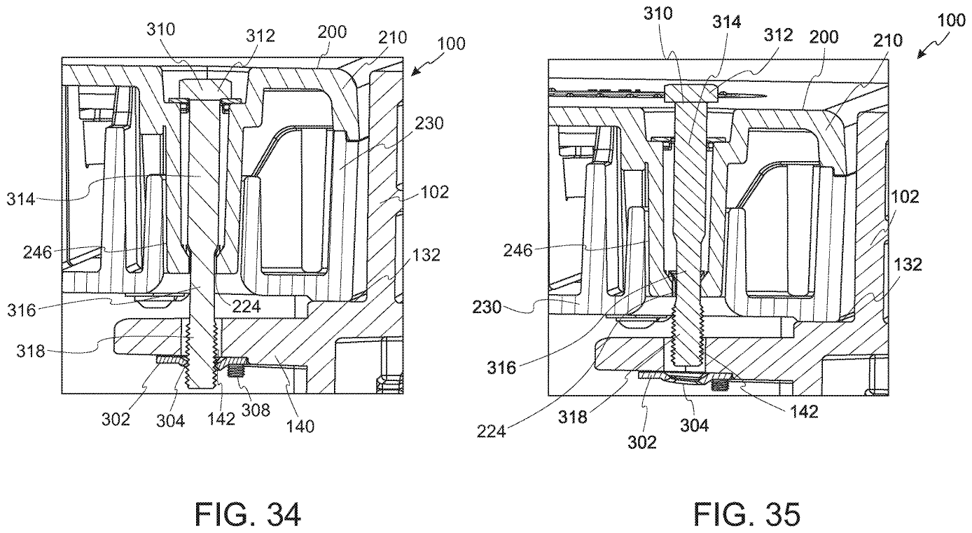

Referring to FIGS. 15, 18, and 19, the bottom piece 230 may have a plurality of openings 246 extending through the bottom piece 230 and corresponding to the locations of the bolt holes 224 (FIGS. 20 and 22) in the top piece 210 (FIGS. 20 and 22) and attachment bolts 310 extending therethrough (see FIGS. 34 and 35). Referring now to FIGS. 34 and 35, each of the openings 246 may receive a portion of the top piece 210 and an attachment bolt 310 therethrough when attaching the cover 200 to the enclosure 102. Referring again to FIG. 18, in embodiments, the bottom piece 230 may have a plurality of fastener openings 248 in the bottom plate 232. The fastener openings 248 in the bottom plate 232 may be configured to receive the fasteners 290 used to attach the top piece 210 to the bottom piece 230 when the two pieces are assembled together to form the cover 200. In embodiments, the openings 248 may be configured to receive the ejector pins 226 on the bottom of the top piece 210 in configurations in which the top piece 210 and bottom piece 230 are heat stack welded together to form the cover 200. In embodiments, the bottom piece 230 may not include the plurality of openings 248 for the ejector pins 226.

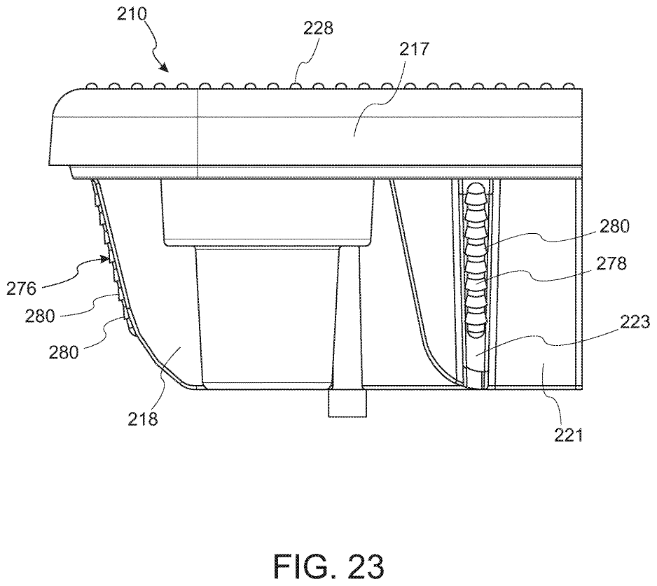

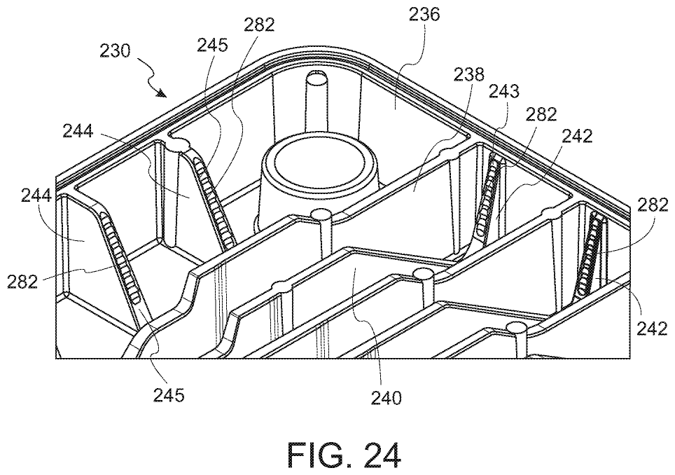

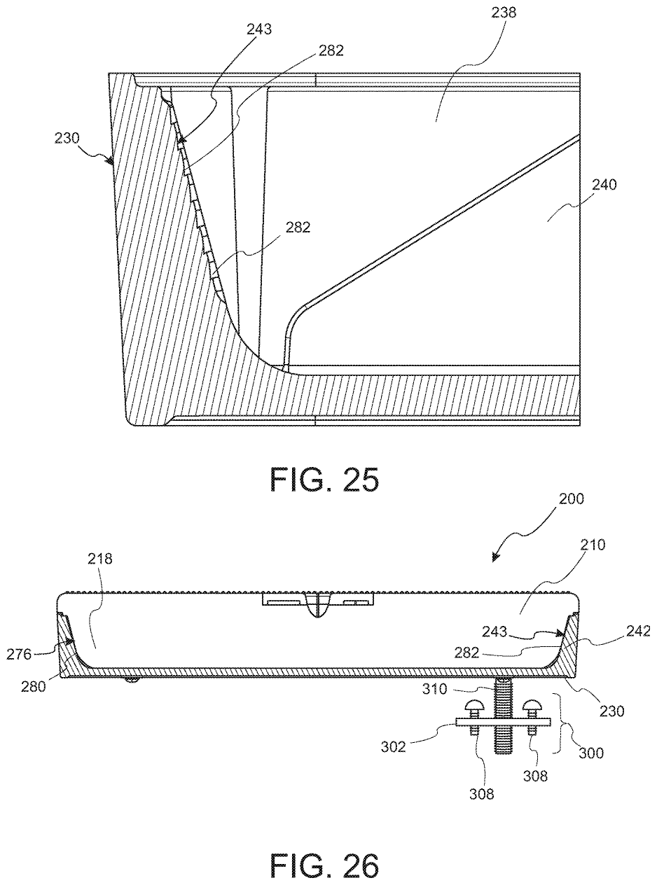

Referring now to FIGS. 20-23, in embodiments, each of the interaction surfaces 276 of the first ribs 218 on the top piece 210 may have a plurality of teeth 280 protruding outward from the interaction surface 276. Similarly, in embodiments, each of the interacting surfaces 278 of the triangular flanges 223 of the end ribs 221 may have a plurality of teeth 280 protruding outward from the interacting surface 278. Referring now to FIGS. 24 and 25, each of the angled engagement surfaces 243 of the triangular gussets 242 of the bottom piece 230 may have a plurality of recesses 282 extending into the engagement surface 243. In embodiments, each of the engagement surfaces 245 of the end gussets 244 of the bottom piece 230 may also have a plurality of recesses 282 extending into the engagement surfaces 245. The recesses 282 on the engagement surfaces 243, 245 on the bottom piece 230 may be shaped or otherwise configured to receive the teeth 280 on the interaction surfaces 276 and interacting surfaces 278 of the top piece 210.

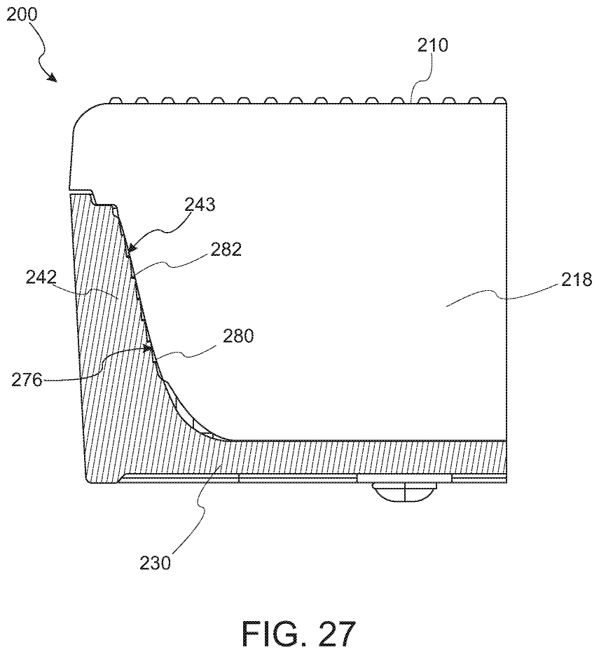

Referring now to FIGS. 26 and 27, when the top piece 210 and the bottom piece 230 are assembled together to produce the cover 200, engagement of the teeth 280 on the interaction surfaces 276 and interacting surfaces 278 of the top piece 210 with the recesses 282 on the engagement surfaces 243, 245 on the bottom piece 230 may operate to maintain contact and engagement between the interaction surfaces 276 on the first ribs 218 and the engagement surfaces 243 of the triangular gussets 242 and between the interacting surfaces 278 of the triangular flanges 223 and the engagement surfaces 245 of the end gussets 244. The interaction between the teeth 280 and the recesses 282 may reduce or prevent slippage of the first ribs 218 out of engagement with the triangular gussets 242. The teeth 280 and recesses 282 may also reduce or prevent slippage of the triangular flanges 223 out of engagement with the engagement surfaces 245 of the end gussets 244. Although shown in FIGS. 20-27 has having the teeth 280 on the top piece 210 and the recesses 282 on the bottom piece 230, it is understood that the teeth 280 could alternatively be formed on the engagement surfaces 243, 245 of the bottom piece 230 and the recesses 282 formed on the interaction surfaces 276 and interacting surfaces 278 of the top piece 210 with comparable effectiveness at stopping slippage between the top piece 210 and bottom piece 230.

The top piece 210 and bottom piece 230 of the cover 200 may be made from the same materials as the enclosure 102. The top piece 210 and bottom piece 230 may be constructed of a polymer material. In embodiments, the top piece 210 and bottom piece 230 may be constructed of high-density polyethylene (HDPE). The polymer may include HDPE and calcium carbonate as a structural additive. The polymer for the top piece 210 and bottom piece 230 may further include pigments and/or colorants, UV inhibitors, lubricants, processing aids, or any combinations of these. The pigments and/or colorants may be added to the polymer masterbatch to provide color to the top piece 210 and bottom piece 230 of the cover 200. The UV inhibitors may be included in the polymer masterbatch to reduce or prevent UV radiation from ambient light from degrading the polymer. The polymer masterbatch for making the top piece 210 and bottom piece 230 may further include processing aids, such as but not limited to lubricants, rheology modifiers, blowing agents, etc., which may be added to the masterbatch to facilitate injection molding of the polymer material to form the top piece 210 and bottom piece 230.

In embodiments, the top piece 210 and bottom piece 230 may be substantially free of fiber reinforcing materials, such as but not limited to glass fibers, carbon fibers, SiC fibers, or any other fibers added to the polymer to impart additional tensile strength. The top piece 210 and bottom piece 230 being substantially free of reinforcing fibers may have less than 0.1 wt. % of reinforcing fibers per unit weight of the polymer material making up the top piece 210 and bottom piece 230. In embodiments, the top piece 210 and the bottom piece 230 of the cover 200 may be made from a polymer material comprising, consisting of, or consisting essentially of HDPE, pigments and/or colorants, optionally a UV inhibitor, and optionally one or more processing aids selected from lubricants, rheology modifiers, blowing agents, and any combinations thereof. In embodiments, the top piece 210 and the bottom piece 230 of the cover 200 may each be made from a polymer material comprising, consisting of, or consisting essentially of HDPE, calcium carbonate, pigments/colorants, optionally a UV inhibitor, and optionally one or more processing aids selected from lubricants, rheology modifiers, and combinations thereof.

The top piece 210 and the bottom piece 230 of the cover 200 may each be formed through injection molding according to methods known in the art. In embodiments, the top piece 210 and the bottom piece 230 of the cover 200 may be formed through structural foam injection molding. After injection molding, the top piece 210 and the bottom piece 230 of the cover 200 may then be assembled together to form the cover 200. In embodiments, the top piece 210 and the bottom piece 230 of the cover 200 may be attached together using fasteners (e.g., screws, bolts, clips, clamps, brackets, etc.), heat stake welds, ultrasonic welds, adhesives, interlocking tabs, or combinations thereof. Referring again to FIG. 9, in embodiments, the top piece 210 and bottom piece 230 maybe rigidly attached together using a plurality of fasteners 290, such as but not limited to screws. In embodiments, washers may be used with the fasteners 190 to facilitate rigid attachment of the top piece 210 and the bottom piece 230.

In embodiments, the top piece 210 and bottom piece 230 of the cover 200 may be attached together with a plurality of heat stake welds. In embodiments, the top piece 210 may include the plurality of ejector pins 226 and the bottom piece 230 may include a plurality of openings 248 configured to receive the ejector pins 226, and the top piece 210 and bottom piece 230 may be assembled by fitting the top piece 210 and the bottom piece 230 together so that the ejector pins 226 are received through and protrude from the openings 248 in the bottom piece 230. The portions of the ejector pins 226 are then heated, melted, and pressed down to form a flat rivet-head type structure (i.e., flange) that prevents the ejector pins 226 from backing back out of the openings 248. In embodiments, the top piece 210 and the bottom piece 230 may be vibration welded together. Other attachment methods of coupling the top piece 210 and the bottom piece 230 together are contemplated, such as but not limited to adhesives or other bonding agents, ultrasonic welding, snap together fittings, compression fitting, or other methods of attachment.

When the top piece 210 and the bottom piece 230 are assembled together to form the cover 200, the first ribs 218 and the second ribs 220 of the top piece 210 alternate with the third ribs 238 and fourth ribs 240 of the bottom piece 230.

Referring again to FIGS. 26 and 27, the interaction surfaces 276 of the first ribs 218 engage the angled engagement surfaces 243 of the triangular gussets 242 of the bottom piece 230 when the top piece 210 and bottom piece 230 are assembled together to form the cover 200. Engagement of the interaction surfaces 276 of the first ribs 218 with the angled engagement surfaces 243 of the triangular gussets 242 redirect downward forces on the cover 200 in a direction outward toward the sidewall 236 of the bottom piece 230. When the cover 200 is installed on the enclosure 102, at least a portion of any weight supported by the cover 200 and exerting a downward force on the cover 200 is distributed outward towards the sidewall 236 of the bottom piece 230, through the engagement of the interaction surfaces 276 of the first ribs 218 with the angled engagement surfaces 243 of the triangular gussets 242, so that the weight exerted on the cover 200 is supported by the ledge 132 of the enclosure 102.

As previously discussed, the teeth 280 and recesses 282 on the interaction surfaces 176 of the first ribs 218 and the engagement surfaces 243 of the triangular gussets 242 may reduce or prevent slippage of the interaction surfaces 176 of the first ribs 218 out of engagement with the engagement surfaces 243 of the triangular gussets 242. In embodiments, one of the interaction surfaces 276 of the first ribs 218 or the engagement surfaces 243 of the triangular gussets 242 may comprise the plurality of teeth 280 extending outward from the surface, and the other one of the interaction surfaces 276 of the first ribs 218 or the engagement surfaces 243 of the triangular gussets 242 may comprise the plurality of recesses 282, where when the interaction surfaces 276 of the first ribs 218 are engaged with the engagement surfaces 243 of the triangular gussets 242, the plurality of teeth 280 are received in the plurality of recesses 282. Engagement of the plurality of teeth 280 with the plurality of recesses 282 may maintain engagement between the interaction surfaces 276 of the first ribs 218 and the engagement surfaces 243 of the triangular gussets 242.

Additionally, the interacting surfaces 278 (i.e., angled side) of the triangular flanges 223 of the end ribs 221 on the top piece 210 engage with the angled engagement surfaces 243 of the end gussets 244 at both ends of the bottom piece 230 to further distribute forces outward towards the sidewall 236 at the two opposing ends of the cover 200. Engagement of the interacting surfaces 278 of the triangular flanges 223 of the end ribs 221 with the angled engagement surfaces 243 of the end gussets 244 may redirect downward forces in a direction outward toward the sidewall 236 on the ends of the bottom piece 230. When the cover 200 is installed on the enclosure 102, at least another portion of any weight supported by the cover 200 and exerting a downward force on the cover 200 will be distributed outward towards the sidewall 236 of the bottom piece 230 on the ends, through the engagement of the interacting surfaces 278 of the triangular flanges 223 of the end ribs 221 with the angled engagement surfaces 243 of the end gussets 24 of the bottom piece 230, so that the weight exerted on the cover 200 is supported by the ledge 132 of the enclosure 102. In embodiments, one of either the interacting surfaces 278 of the plurality of triangular flanges 223 of the end ribs 221 or the engagement surfaces 245 of the end gussets 244 comprise the plurality of teeth 280 extending outward from the surfaces, and the other one of either the interacting surfaces 278 of the plurality of triangular flanges 223 of the end ribs 221 or the engagement surfaces 245 of the end gussets 244 comprise the plurality of recesses 282. When the interacting surfaces 278 of the triangular flanges 223 are engaged with the engagement surfaces 245 of the end gussets 244, the plurality of teeth 280 are received in the plurality of recesses 282, and engagement of the plurality of teeth 280 with the plurality of recesses 282 may maintain engagement of the interacting surfaces 278 of the triangular flanges 223 with the engagement surfaces 245 of the end gussets 244.

The configuration of the ribs of the top and bottom pieces of the cover 200 enable the cover 200 to withstand and distribute forces outward to the walls and the ledge 132 of the enclosure 102 without breaking and without requiring additional support structures made from metal, wood, concrete, polymer concrete, or other materials different from the polymer batch materials used to injection mold the various parts of the enclosure 102 and cover 200. In embodiments, cover 200 and enclosure 102 do not include any support structures made from a material different from the polymer materials used to injection mold the enclosure 102 and cover 200. The term “support structure” refers to a structure intended to provide increased bend strength or tensile strength support for the cover 200 and includes bars, braces, lattices, plates, or other supporting structure but does not include fasteners used to attach the top piece 210 to the bottom piece 230 to form the cover 200 or to attach the two pieces of the enclosure 102 together. In embodiments, the cover 200 does not include any support structure made from a metal, wood, concrete, polymer concrete, or any other material having a greater strength (bend strength, tensile strength, etc.) compared to the polymer composition of the enclosure 102. Basically the utility enclosure assembly 100 disclosed herein is constructed entirely of the polymer composition, notwithstanding the attachment mechanism and any fasteners used to couple parts together. In embodiments, the utility enclosure assembly 100 may be subjected to greater loads or more frequent loading, and the enclosure assembly 100 may include a metal bar (not shown) installed in the U-shaped recesses 170 on either side of the enclosure 102.

The utility enclosure assembly 100 comprising the enclosure 102 and the cover 200 may satisfy the requirements in ANSI/SCTE 77 (2023) Tier 22 for utility enclosures. In embodiments, the utility enclosure assembly 100, may be able to withstand at least 22,500 pounds of force without failing, as determined according to the cover vertical load test in ANSI/SCTE 77.3 (2023).

In embodiments, the utility enclosure assembly 100 may be capable of withstanding at least about 22,500 pounds of force without failing, as determined according to the box vertical sidewall test for boxes <60″ long in ANSI/SCTE 77.2 (2023). In embodiments, the utility enclosure assembly 100 may be able to withstand at least about 2,400 pounds of force without failing, as determined according to the box lateral sidewall test for boxes <60″ long in ANSI/SCTE 77.1 (2023).

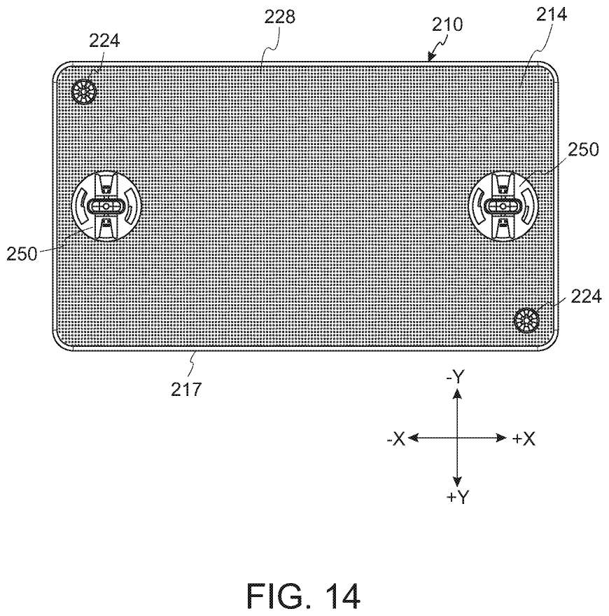

Referring again to FIGS. 9 and 14, in embodiments, the cover 200 may include a tread pattern 228 disposed on or formed integral with the top surface 214 of the top piece 210 of the cover 200. In embodiments, the tread pattern 228 may be formed integral with the top surface 214 during the injection molding process, such as by including the tread pattern 228 in the mold used for injection molding. Referring again to FIG. 21, in embodiments, the tread pattern 228 may comprise a plurality of protrusions extending upward (i.e., in the +Z direction of the coordinate axis in FIG. 21) from the top surface 214 of the top piece 210 of the cover 200. The plurality of protrusions of the tread pattern 228 may be of generally uniform shape and size and may be evenly spaced apart from one another. In embodiments, the protrusions of the tread pattern 228 may be semispherical or cylindrical. The protrusions of the tread pattern 228 may be made from the same material used to make the top piece 210 of the cover 200.

In embodiments, the tread pattern 228, or the top surface 214 more generally, of the top piece 210 may be surface treated after injection molding to produce a roughened surface texture over the top surface 214 and/or the tread pattern 228. The roughened surface texture on the tread pattern 228 may improve grip quality on the top surface 214 and may additionally hide imperfections on the first surface, such as deformation, damage, marks, fingerprint smudges, etc. In embodiments, the roughened surface texture on the tread pattern 228 may be made by dry blasting the top surface 214 with a particulate, such as aluminum oxide. In embodiments, the surface texture applied to the tread pattern 228 may conform to SPI-D2 or SPI-D3 of the Society of Plastics Industry (SPI) surface finish standards. Other surface finishes are contemplated, such as but not limited to VDI #20-VDI #45 finish, an MT-11020 finish, or other roughened surface finish. In embodiments, the surface finish on the top surface 214 may be characterized by surface roughness Ra, which may be at least 1, such as from about 1 to about 20.

### Name ID Puck

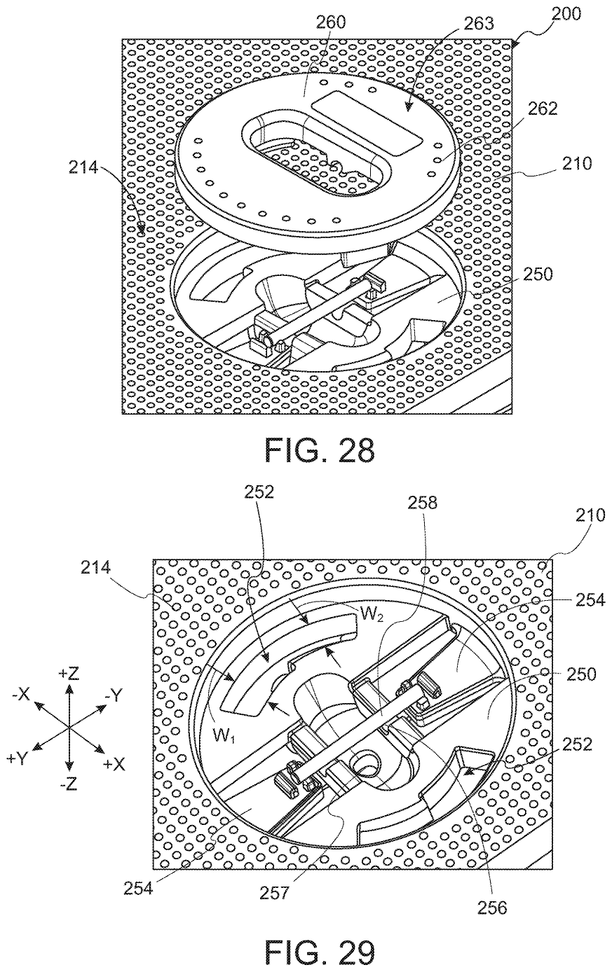

Referring again to FIGS. 1 and 9, the utility enclosure assembly 100 may further include one or more name ID pucks 260 removably attachable to the cover 200. Referring now to FIG. 28, the cover 200, in particular the top piece 210 of the cover 200, may have a puck attachment fitting 250 configured to receive the name ID puck 260 and secure the name ID puck 260 to the cover 200. The puck attachment fitting 250 may be recessed relative to the top surface 214 of the top piece 210 of the cover 200 so that a top surface 263 the name plate 262 is flush with the top surface 214 of the top piece 210 of the cover 200. The puck attachment fitting 250 may have an outer shape configured to receive the name plate 262 of the name ID puck 260.

Referring to FIG. 29, the puck attachment fitting 250 may have one or a plurality of arcuate openings 252, which may each have a narrow portion and a wide portion. The wide portion of each arcuate opening 252 may be large enough to allow the flange 266 at the end of the rigid tabs 264 on the name ID puck 260 to pass through the puck attachment fitting 250, and the narrow portion may be narrow enough to hold the flange 266 at the end of the rigid tabs 264 on the name ID puck 260. In other words, the wide portion may have a first width W₁ larger than the radial thickness R₁ of the flange 266 (FIG. 31) at the bottom end of each of the plurality of rigid tabs 264 on the name ID puck 260. The narrow portion may have a second width W₂ that is smaller than the radial thickness R₂ of the flange 266 (FIG. 31) at the bottom end of the plurality of rigid tabs 264 on the name ID puck 260 and larger than the radial thickness of the plurality of rigid tabs.

The puck attachment fitting 250 may further include two resilient tabs 254 extending inward from an outer periphery of the puck attachment fitting 250. The resilient tabs 254 may be flexible enough to be deflected downward during installation of the name ID puck 260. The resilient tabs 254 may each have a plurality of protrusions on the top surface forming a cradle, which may be configured to receive the ends of the lift pin 258. The puck attachment fitting 250 may also include a recessed channel 256 in a central portion of the puck attachment fitting 250. The recessed channel 256 may receive a portion of the lift pin 258 and may allow the lift pin 258 to move downward during deflection of the resilient tabs 254 during installation and/or removal of the name ID puck 260. The puck attachment fitting 250 may have a drainage hole 257 to drain liquids, such as but not limited to rain water, out of the puck attachment fitting 250.

The puck attachment fitting 250 may further include the lift pin 258, which may be a thin rigid bar that extends from the cradle of one resilient tab 254, through the recessed channel 256 of the central portion of the puck attachment fitting 250, and to the cradle of the other resilient tab 254. The lift pins 258 may be used to remove the cover 200 from the enclosure 102 by inserting a lifting tool or other tool (e.g., pliers, hook, etc.) through a center opening in the name ID puck 260 and hooking the tool under the lift pin 258. When installing or removing the name ID puck 260, downward force applied to the lift pin 258 translates to the resilient tabs 254 causing the resilient tabs 254 to deflect downward. The recessed channel 256 enables the lift pin 258 to travel in the −Z direction when a downward force is applied to the lift pin 258.

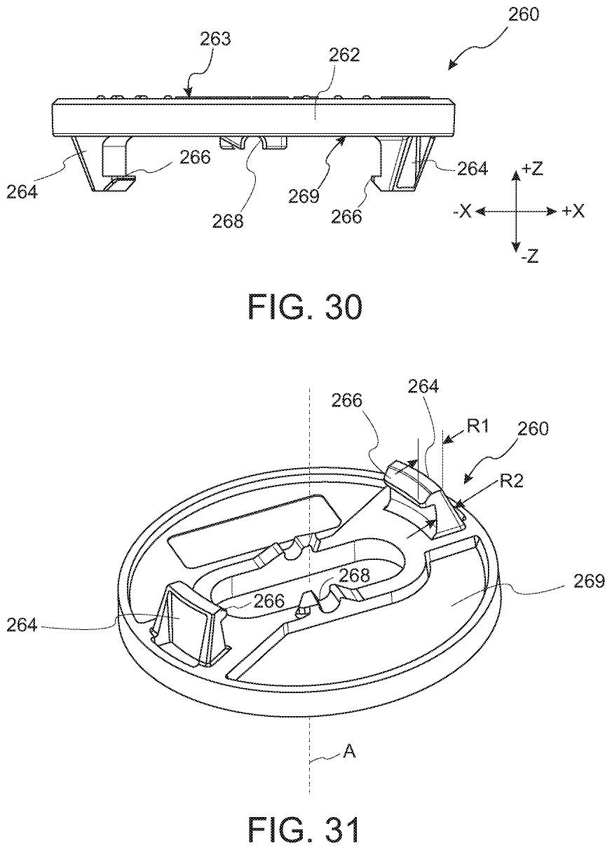

Referring now to FIGS. 30 and 31, the name ID puck 260 may include the name plate 262 having a top surface 263 and two rigid tabs 264 extending downward (−Z direction of coordinate axis in FIG. 30). The name plate 262 may have the company name or any other pertinent information formed (e.g., embossed, molded, etc.) or printed on the top surface 263 of the name plate 262. The two rigid tabs 264 may each have a flange 266 at the bottom end of the rigid tabs 264. Referring to FIG. 31, each flange 266 may have a radial thickness R₁ greater than a radial thickness R₂ of the rigid tab 264. The radial thickness refers to the thickness of the flange 266 or rigid tab 264 in a radial direction relative to the center axis A of the name ID puck 260. The flange 266 may be small enough to fit through the wide portion of one of the arcuate openings 252 but large enough to be retained by the narrow portion of the arcuate openings 252. The name ID puck 260 may also have a recessed channel 268 on a bottom surface 269 of the name plate 262. The recessed channel 268 may be shaped to receive the lift pin 258 when the name ID puck 260 is installed on the cover 200.

The name ID puck 260 may be installed on the cover 200 by first aligning the rigid tabs 264 of the name ID puck 260 with the wide portions of the arcuate openings 252 in the puck attachment fitting 250 on the top piece 210 of the cover 200. A downward force is applied to the name ID puck 260, which causes the flanges 266 at the end of the two rigid tabs 264 to pass through the wide portions of the two arcuate openings 252 in the puck attachment fitting 250. The downward force also causes the bottom surface 269 of the name plate 262 to contact the lift pin 258 and push the lift pin 258 downward (−Z direction), which deflects the resilient tabs 254. While applying the downward force, the name ID puck 260 is rotated about a center axis (e.g., clockwise or counterclockwise). Rotation of the name ID puck 260 causes the rigid tabs 264 on the name ID puck to travel into the narrow portions of the two arcuate openings 252 and causes the bottom surface 269 of the name plate 262 to rotate relative to the lift pin 258. The lift pin 258 remains rotationally constrained by the cradles on the top surfaces of the two resilient tabs 254 and by the recessed channel 256 of the puck attachment fitting 250. When the name ID puck 260 is rotated so that the recessed channel 268 on the bottom surface 269 of the name plate 262 is aligned with the lift pin 258, the lift pin 258 snaps into the recessed channel 268 to fix the rotational position of the name ID puck 260 in the installed position. In the installed position, axial and radial movement of the name ID puck 260 is restrained by the flanges 266 in contact with the bottom of the puck attachment fitting 250 in the narrow portions of the two arcuate openings 252. In the installed position, the rotational position of the name ID puck 260 is restrained by the lift pin 258 received in the recessed channel 268 on the bottom surface 269 of the name plate 262. The name ID puck 260 can be removed by applying a downward force on the lift pin 258 and then rotating the name ID puck 260 in the opposite direction until the rigid tabs 264 on the name ID puck 260 are once again aligned with the wide portions of the two arcuate openings 252.

### Attachment Mechanism

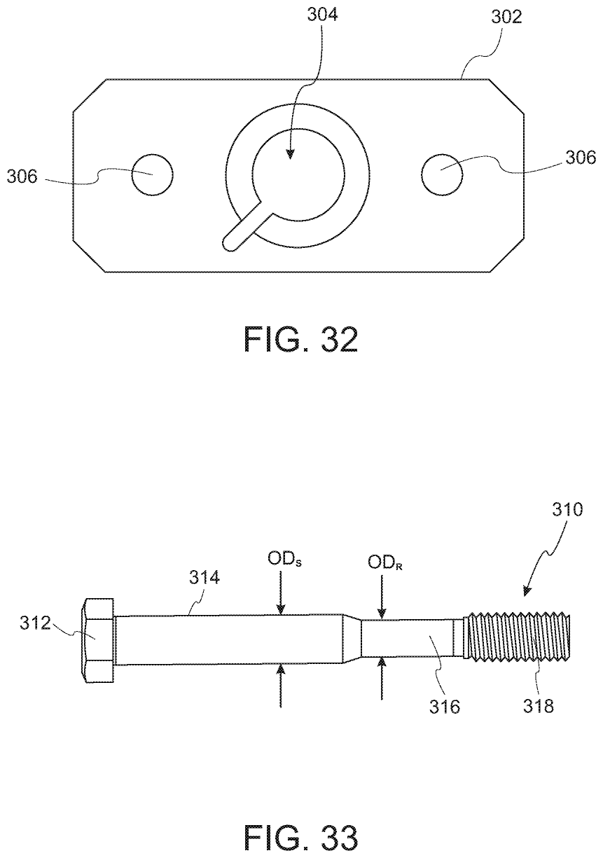

Referring again to FIGS. 6 and 26, the utility enclosure assembly 100 may include an attachment mechanism 300 for attaching the cover 200 to the enclosure 102. In embodiments, the utility enclosure assembly 100 may include a plurality of nut plates 302 and a plurality of attachment bolts 310 (FIG. 8), which in combination provide the attachment mechanism 300. Referring to FIG. 6, each nut plate 302 may be attached to one of the triangular attachment flanges 140, which maybe disposed in the corners of the enclosure 102 just below the ledge 132. Referring now to FIG. 32, each nut plate 302 may have a central opening 304 and two attachment openings 306, one on either side of the central opening 304. The central opening 304 may be threaded. Referring again to FIGS. 6 and 7, the nut plate 302 may be attached to the triangular attachment flanges 140 so that the central opening 304 (FIGS. 6 and 32) of the nut plate 302 is aligned with the primary hole 142 in the triangular attachment flange 140 (FIG. 7). Referring to FIG. 6, each nut plate 302 may be attached to the triangular attachment flange 140 with one or more fasteners 308 (e.g., screws, bolts, clips, adhesives, brackets, rivets, etc.). In embodiments, each nut plate 302 may be attached to the corresponding triangular attachment flange 140 with two screws or bolts, which may be received through the attachment openings 306 of the nut plate 302 (FIG. 32) and in the secondary holes 144 of the triangular attachment flange 140 (FIG. 7). The nut plates 302 may be attached to the top surfaces or the underside surfaces of the triangular attachment flanges 140.

The attachment mechanism 300 further includes the plurality of attachment bolts 310. Referring now to FIG. 33, in embodiments, each of the attachment bolts 310 may be a captive bolt having a head 312, a shank 314, a relief region 316, and a threaded region 318. The relief region 316 may have an outer diameter ODR that is less than the outer diameter ODs of the shank 314 and the outer diameter of the threaded region 318. The attachment bolts 310 being captive bolts may maintain the attachment bolts 310 in engagement with the cover 200 when the attachment bolts 310 are unscrewed from the nut plate, which may reduce or prevent loss of the attachment bolts 310 when removing the cover 200 from the enclosure assembly 100. Referring to FIG. 34, the attachment bolt 310 attaches the cover 200 to the enclosure 102. The cover 200, which comprises the top piece 210 and the bottom piece 230, is placed on the ledge 132 of the enclosure 102. The attachment bolts 310 are passed through the bolt holes 224 in the top piece 210 of the cover 200, through the openings 246 in the bottom piece 230, and through the primary hole 142 in the triangular attachment flange 140. The threaded region 318 of the attachment bolt 310 is threaded into the central opening 304 in the nut plate 302 to secure the cover 200 to the enclosure 102.

Referring to FIG. 35, when removing the cover 200, the attachment bolt 310 is loosened (e.g., unthreaded or unscrewed) completely from the central opening 304 of the nut plate 302. The relief region 316 of the attachment bolt 310 allows the attachment bolt 310 to be unscrewed completely from the nut plate 302. However, the shank 314 and the threaded region 318 both have outer diameters that are greater than the outer diameter ODR of the relief region 316, which maintains engagement of the attachment bolt 310 with the cover 200. The attachment bolt 310 is thus loosened from the enclosure 102, but remains secured with the top piece 210 of the cover 200. Specifically, the relief region 316 passes through the bolt hole 224 in the top piece 210, and the shank 314 and threaded region 318 prevents the attachment bolt 310 from disengaging with the bolt hole 224 of the top piece 210 without further actions on the part of the operator. To remove the attachment bolt 310 completely from the cover 200, the attachment bolt 310 can be additionally unthreaded out of the bolt hole 224 in the top piece 210 of the cover 200.

Referring again to FIG. 34, to attach the cover 200 to the enclosure 102, the nut plates 302 are first installed, such as by attaching the nut plates 302 to the triangular attachment flanges 140 of the enclosure 102 using one or more fasteners 308. To attach the cover 200, the cover 200 is installed over the top opening 116 of the enclosure 102 so that the bottom piece 230 of the cover 200 is supported directly on the ledge 132 of the enclosure 102. Attachment bolts 310 are then inserted through the bolt holes 224 in the top piece 210 and openings 246 in the bottom piece 230 of the cover 200. The attachment bolts 310 are then passed through the primary holes 142 in the triangular attachment flanges 140 and received in the central openings 304 of the nut plates 302. The attachment bolts 310 are then screwed into the central openings 304 of the nut plates 302. Threaded engagement of the attachment bolts 310 with the nut plates 302 may secure the cover 200 to the enclosure 102.

Referring now to FIG. 36, another embodiment of an enclosure assembly 100′ is schematically depicted. The enclosure assembly 100′ has a size different from the size of the enclosure assembly 100 of FIG. 1, but may still have same parts as the enclosure assembly 100 of FIG. 1. For instance, the enclosure assembly 100′ of FIG. 36 may have the enclosure 100 having the side walls 110 and end walls 112. The outer surface 120 of the side walls 110 and end walls 112 may have one or more horizontal ribs 122, one or more vertical ribs 124, or both. The enclosure 102 may have any of the features of the enclosures 102 previously discussed herein. The enclosure assembly 100′ may further include the cover 200, which may have any of the features previously described herein for the cover 200.

In a first aspect disclosed herein, a utility enclosure assembly may comprise an enclosure and a cover, wherein: the utility enclosure assembly may be configured to be installed underground with a top surface of the cover proximate grade level; the enclosure may comprise an inner surface having a ledge proximate a top of the enclosure; the ledge supports the cover when the cover is engaged with the enclosure; the enclosure and the cover are constructed of high-density polyethylene and optionally calcium carbonate; and the utility enclosure assembly is compliant with the Tier 22 requirements for underground utility enclosures, as determined according to the standard test methods in ANSI/SCTE 77 (2023).

A second aspect disclosed herein may include aspect 1, wherein the cover comprises a top piece and a bottom piece.

A third aspect disclosed herein may include aspect 2, wherein: the top piece comprises a plurality of first ribs extending from a bottom surface of the top piece; each of the plurality of first ribs have an angled interaction surface at each end; the bottom piece comprises a plurality of triangular gussets extending from a top surface of the bottom piece; each of the triangular gussets have an angled engagement surface complimentary to and aligned with one of the angled interaction surfaces of the plurality of first ribs; and when the top piece and the bottom piece are assembled together to form the cover, the interaction surfaces of the plurality of first ribs engage with the engagement surfaces of the plurality of triangular gussets to redirect the downward forces outward towards a sidewall of the cover.

A fourth aspect disclosed herein may include aspect 2, wherein: the top piece comprises a plurality of first ribs having interaction surfaces at each end; the bottom piece comprises a plurality of triangular gussets each having an engagement surface complimentary to and aligned with one of the interaction surfaces of the first ribs; and when the top piece and the bottom piece are assembled together to form the cover, the interaction surfaces of the first ribs engage the engagement surfaces of the triangular gussets, wherein the engagement redirects downward forces exerted on the top piece of the cover horizontally outward toward a sidewall of the cover.

A fifth aspect disclosed herein may include any one of aspects 3 or 4, wherein: one of the interaction surfaces of the first ribs or the engagement surfaces of the triangular gussets comprise a plurality of teeth extending outward; the other one of the interaction surfaces of the first ribs or the engagement surfaces of the triangular gussets comprise a plurality of recesses; when the interaction surfaces of the first ribs are engaged with the engagement surfaces of the triangular gussets, the plurality of teeth are received in the plurality of recesses; and engagement of the plurality of teeth with the plurality of recesses maintains engagement of the interaction surfaces of the first ribs with the engagement surfaces of the triangular gussets.

A sixth aspect disclosed herein may include any one of aspects 3-5, wherein the top piece further comprises a plurality of second ribs, where the plurality of second ribs stiffen a middle of the top piece of the cover.

A seventh aspect disclosed herein may include any one of aspects 3-6, wherein the bottom piece comprises: the sidewall of the cover; and a plurality of third ribs extending from a top surface of the bottom piece, wherein: the plurality of third ribs extend a width of the bottom piece from the sidewall a first side of the bottom piece to the sidewall on a second side of the bottom piece; each of the plurality of third ribs is coupled to the sidewall on both ends; and the plurality of third ribs hold the sidewalls in place to reduce or prevent outward bowing of the sidewalls.

An eighth aspect disclosed herein may include the seventh aspect, wherein the bottom piece further comprises a plurality of fourth ribs extending from the upper surface of the bottom piece, wherein the plurality of fourth ribs stiffen a middle of the bottom piece of the cover.

A ninth aspect disclosed herein may include any one of aspects 2-8, wherein the top piece and the bottom piece are attached together with one or more fasteners, welds, adhesives, interlocking tabs, heat stake welds, or combinations thereof.

A tenth aspect disclosed herein may include any one of aspects 1-9, wherein the cover comprises a tread pattern on a top surface of the cover.

An eleventh aspect disclosed herein may include any one of aspects 1-10, further comprising one or a plurality of name ID pucks attachable to a top surface of the cover, wherein: the name ID pucks comprise a replaceable lift pin, a name plate, and a plurality of rigid tabs; the cover comprises a puck attachment fitting comprising a plurality of arcuate openings and two resilience tabs; and the name ID puck is installed and locked in place in the puck attachment fitting.

A twelfth aspect disclosed herein may include any one of aspects 1-11, wherein the enclosure comprises a plurality of horizontal ribs and a plurality of vertical ribs extending from an outer surface of the enclosure.

A thirteenth aspect disclosed herein may include any one of aspects 1-12, wherein the enclosure comprises one or a plurality of foot pockets configured to enable ingress and egress from the enclosure from above grade.

A fourteenth aspect disclosed herein may include any one of aspects 1-13, wherein the enclosure comprises one or a plurality of tracer tie downs.

A fifteenth aspect disclosed herein may include any one of aspects 1-14, wherein the utility enclosure assembly withstands a vertical load on the cover of at least 22,500 pounds of force without failing, as determined according to the cover vertical load test in ANSI/SCTE 77.3 2023.

A sixteenth aspect disclosed herein may include any one of aspects 1-15, wherein the utility enclosure assembly withstands a lateral load of at least about 2,400 pounds of force, as determined according to the box lateral sidewall test for boxes less than 60″ long in ANSI/SCTE 77.1 2023.

A seventeenth aspect disclosed herein may include any one of aspects 1-16, wherein the enclosure, the cover, or both consist of HDPE, optionally calcium carbonate, and optionally one or more additive selected from the group consisting of pigments, colorants, UV inhibitors, processing aids, and any combination thereof, wherein the processing aids are selected from the group consisting of lubricants, rheology modifiers, blowing agents, and combinations thereof.

An eighteenth aspect disclosed herein may include any one of aspects 1-17, wherein the enclosure and the cover do not include fiber reinforcing materials.

A nineteenth aspect disclosed herein may include any one of aspects 1-18, wherein the utility enclosure assembly does not have any supplemental structural support constructed of metal, wood, concrete, polymer concrete, or other material having a strength greater than HDPE or HDPE plus calcium carbonate.

A twentieth aspect disclosed herein may include any one of aspects 1-19, further comprising at least one attachment mechanism configured to attach the cover to the enclosure.

A twenty-first aspect disclosed herein may be directed to a cover for an underground utility enclosure, the cover comprising a top piece and a bottom piece, wherein: the top piece has a plurality of first ribs and the bottom piece has a plurality of triangular gussets; and when the top piece and the bottom piece are assembled together to form the cover, the plurality of first ribs engage with the plurality of triangular gussets to redirect a portion of downward forces exerted on the cover outward towards a sidewall of the cover.

A twenty-second aspect disclosed herein may include aspect 21, wherein: the plurality of first ribs extend downward from a bottom surface of the top piece; each of the plurality of first ribs have an angled interaction surface at each end; the plurality of triangular gussets extending upward from a top surface of the bottom piece; each of the triangular gussets have an angled engagement surface complimentary to and aligned with one of the angled interaction surfaces of the plurality of first ribs; and when the top piece and the bottom piece are assembled together to form the cover, the interaction surfaces of the plurality of first ribs engage with the engagement surfaces of the plurality of triangular gussets to redirect the portion of the downward forces outward towards the sidewall of the cover.

A twenty-third aspect disclosed herein may include any one of aspects 21-22, wherein: the plurality of first ribs have interaction surfaces at each end; the plurality of triangular gussets each have an engagement surface complimentary to and aligned with one of the interaction surfaces of the first ribs; and when the top piece and the bottom piece are assembled together to form the cover, the interaction surfaces of the first ribs engage the engagement surfaces of the triangular gussets, wherein the engagement redirects the at least a portion of the downward forces exerted on the top piece of the cover horizontally outward toward the sidewall of the cover.

A twenty-fourth aspect disclosed herein may include aspect 23, wherein: one of either the interaction surfaces of the first ribs or the engagement surfaces of the triangular gussets comprise a plurality of teeth extending outward; the other one of either the interaction surfaces of the first ribs or the engagement surfaces of the triangular gussets comprise a plurality of recesses; when the interaction surfaces of the first ribs are engaged with the engagement surfaces of the triangular gussets, the plurality of teeth are received in the plurality of recesses; and engagement of the plurality of teeth with the plurality of recesses maintains engagement of the interaction surfaces of the first ribs with the engagement surfaces of the triangular gussets.

A twenty-fifth aspect disclosed herein may include any one of aspects 21-24, wherein the top piece further comprises a plurality of second ribs, where the plurality of second ribs stiffen a middle of the top piece of the cover.

A twenty-sixth aspect disclosed herein may include any one of aspects 21-25, wherein the bottom piece comprises: the sidewall of the cover; and a plurality of third ribs extending from a top surface of the bottom piece, wherein: the plurality of third ribs extend a width of the bottom piece from the sidewall a first side of the bottom piece to the sidewall on a second side of the bottom piece; each of the plurality of third ribs is coupled to the sidewall on both ends; and the plurality of third ribs hold the sidewalls in place to reduce or prevent outward bowing of the sidewalls.

A twenty-seventh aspect disclosed herein may include any one of aspects 21-26, wherein the bottom piece further comprises a plurality of fourth ribs extending from the upper surface of the bottom piece, wherein the plurality of fourth ribs stiffen a middle of the bottom piece of the cover.

A twenty-eighth aspect disclosed herein may include any one of aspects 21-27, wherein: the top piece further comprises an end rib at each end of the top piece; each end rib comprises a plurality of triangular flanges, each having an interacting surface; the bottom piece further comprises a plurality of end gussets, each end gusset having an engagement surface; and when top piece and the bottom piece are assembled together, the interacting surfaces of the triangular flanges engage the engagement surfaces of the end gussets, wherein the engagement redirects the at least a portion of the downward forces exerted on the top piece of the cover horizontally outward toward the sidewall of the cover.

A twenty-ninth aspect disclosed herein may include aspect 28, wherein: one of either the interacting surfaces of the plurality of triangular flanges of the end ribs or the engagement surfaces of the end gussets comprise a plurality of teeth extending outward; the other one of either the interacting surfaces of the plurality of triangular flanges of the end ribs or the engagement surfaces of the end gussets comprise a plurality of recesses; when the interacting surfaces of the triangular flanges are engaged with the engagement surfaces of the end gussets, the plurality of teeth are received in the plurality of recesses; and engagement of the plurality of teeth with the plurality of recesses maintains engagement of the interacting surfaces of the triangular flanges with the engagement surfaces of the end gussets.

A thirtieth aspect disclosed herein may include any one of aspects 1-20, wherein the utility enclosure assembly withstands a vertical sidewall load of at least about 22,500 pounds of force, as determined according to the box vertical sidewall test for boxes less than 60″ long in ANSI/SCTE 77.2 (2023).

A thirty-first aspect disclosed herein may be directed to a utility enclosure assembly comprising an enclosure and a cover, wherein: the utility enclosure assembly is configured to be installed underground with a top surface of the cover proximate grade level; the enclosure comprises an inner surface having a ledge proximate a top of the enclosure; the ledge supports the cover when the cover is engaged with the enclosure; and the inner surface of the enclosure comprises one or a plurality of foot pockets configured to enable egress from the enclosure.

A thirty-second aspect disclosed herein may include aspect 31, wherein each of the plurality of foot pockets conforms to Occupational Safety and Health Administration (OSHA) standards for ladders.

A thirty-third aspect disclosed herein may include either one of aspects 31 or 32, wherein each of the plurality of foot pockets is sized to receive a human foot.

A thirty-fourth aspect disclosed herein may include any one of aspects 31-33, wherein each of the plurality of foot pockets comprise ridges on an upper surface of the foot pocket to prevent slippage.

A thirty-fifth aspect disclosed herein may include any one of aspects 31-34, wherein the plurality of foot pockets are disposed in a side wall of the enclosure, wherein the side wall of the enclosure has a plurality of horizontal ribs and a plurality of vertical ribs on an outer surface of the side wall.

A thirty-sixth aspect disclosed herein may be directed to a utility enclosure assembly comprising an enclosure, a cover, and an attachment mechanism, wherein: the utility enclosure assembly is configured to be installed underground with a top surface of the cover proximate grade level; the enclosure comprises an inner surface having a ledge proximate a top of the enclosure; the ledge supports the cover when the cover is engaged with the enclosure; the attachment mechanism comprises an attachment bolt; engagement of the attachment bolt with the cover and the enclosure securely attaches the cover to the enclosure; and the attachment bolt is a captive bolt configured to maintain engagement with the cover when the captive bolt is disengaged from the enclosure.

A thirty-seventh aspect disclosed herein may include aspect 36, wherein the attachment mechanism further comprises a nut plate attached to the enclosure, wherein the nut plate is configured to receive the attachment bolt, and engagement of the attachment bolt with the nut plate attaches the cover to the enclosure.

A thirty-eighth aspect disclosed herein may include either one of aspects 36 or 37, wherein: the captive bolt comprises a head, a shank, a relief region, and a threaded region; the relief region is positioned between the shank and the threaded region and has an outer diameter less than an outer diameter of the shank and the threaded region; the relief region maintains the attachment bolt in engagement with the cover when the attachment bolt is unthreaded from the nut plate.

A thirty-ninth aspect disclosed herein may be directed to a utility enclosure assembly comprising an enclosure, a cover, and a name ID puck attachable to a top surface of the cover, wherein: the utility enclosure assembly is configured to be installed underground with a top surface of the cover proximate grade level; the enclosure comprises an inner surface having a ledge proximate a top of the enclosure; the ledge supports the cover when the cover is engaged with the enclosure; the name ID pucks comprises a replaceable lift pin, a name plate, and a plurality of rigid tabs; the cover comprises a puck attachment fitting comprising a plurality of arcuate openings and a plurality of resilient tabs; and the name ID puck is removably attached to the cover via the puck attachment fitting.

A fortieth aspect disclosed herein may include aspect 39, wherein the puck attachment fitting is recessed relative to the top surface of the cover, wherein when the name ID puck is installed and locked in place in the puck attachment fitting, a top surface of a name plate of the name ID puck is even with the top surface of the cover.

A forty-first aspect disclosed herein may include either one of aspects 39 or 40, wherein a number of the plurality of arcuate openings of the puck attachment fitting is the same as a number of the plurality of rigid tabs on the name ID puck.

A forty-second aspect disclosed herein may include any one of aspects 39-41, wherein each of the plurality of rigid tabs has a flange at a bottom end of the rigid tab, wherein the flange has a radial thickness greater than a radial thickness of the rigid tab.

A forty-third aspect disclosed herein may include aspect 42, wherein: each of the plurality of arcuate openings in the puck attachment fitting has a narrow portion and a wide portion; the wide portion has a width larger than the radial thickness of the flange at the bottom end of each of the plurality of rigid tabs on the name ID puck; and the narrow portion has a width smaller than the radial thickness of the flange at the bottom end of the plurality of rigid tabs on the name ID puck and larger than the radial thickness of the plurality of rigid tabs.

Forty-fourth aspect disclosed herein may include aspect 43, wherein when the plurality of rigid tabs are inserted through the wide portions of the plurality of arcuate openings and the name ID puck is rotated towards the narrow portion of the plurality of arcuate openings, the narrow portion of the plurality of arcuate openings holds the flanges at the bottom ends of the plurality of rigid tabs to secure the name ID puck to the attachment fitting.

A forty-fifth aspect disclosed herein may include any one of aspects 39-44, wherein the plurality of resilient tabs extend inward from an outer periphery of the puck attachment fitting, and wherein each of the plurality of resilient tabs is configured to deflect downward during installation, removal, or both of the name ID puck with the puck attachment fitting.

A forty-sixth aspect disclosed herein may include aspect 45, wherein when the name ID puck is installed and locked in place in the attachment fitting, each of the plurality of resilient tabs exerts a force against a bottom surface of the name ID puck.

A forty-seventh aspect disclosed herein may include either one of aspects 45 or 46, wherein each of the plurality of resilient tabs has a plurality of protrusions on a top surface of the resilient tab, wherein the plurality of protrusions define a cradle configured to receive an end of the replaceable lift pin when the name ID puck is installed and locked in place in the puck attachment fitting.

A forty-eighth aspect disclosed herein may include any one of aspects 39-47, wherein the puck attachment fitting comprises a recessed channel in a central portion of the puck attachment fitting, wherein the recessed channel is configured to receive the replaceable lift pin therein and allow the replaceable lift pin to move downward in response to downward deflection of the plurality of resilient tabs during installation, removal, or both of the name ID puck with the puck attachment fitting.

A forty-ninth aspect disclosed herein may include any one of aspects 39-48, wherein the puck attachment fitting comprises a drainage hole configured to drain liquid out of the puck attachment fitting.

A fiftieth aspect disclosed herein may include any one of aspects 39-49, wherein the replaceable lift pin is a thin rigid bar.

A fifty-first aspect disclosed herein may include aspect 50, wherein the replaceable lift pin extends from a cradle of a first one of the plurality of resilient tab, through a recessed channel of a central portion of the puck attachment fitting, and to a cradle of a second one of the plurality of resilient tabs.

A fifty-second aspect disclosed herein may include any one of aspects 50-51, wherein when the name ID puck is installed and locked in place in the puck attachment fitting, the lift pin is configured to enable use of a lifting tool to remove the cover from the enclosure.

### Examples

The various aspects of the present disclosure will be further clarified by the following examples. The examples are illustrative in nature and should not be understood to limit the subject matter of the present disclosure.

In these Examples, an enclosure and cover according to the present disclosure were tested for structural load using the test methods ANSI/SCTE 77 2023 for underground enclosure structure load testing. The utility enclosure assembly had nominal dimensions of 17 inches (nominal width) by 30 inches (nominal length) by 24 inches (nominal depth). The enclosure had outside dimensions of 22 inches wide, 32.75 inches long, and about 24 inches deep. The cover had outer dimensions of 17.25 inches wide and 30.25 inches long. The opening in the top of the enclosure and ledge on which the cover rests were dimensioned to accommodate the side of the cover. The enclosure conformed to the design shown in FIGS. 2-7. The cover had the design shown in FIGS. 9 and 20-27, in which the top piece 210 incorporated the teeth 280 on the interaction surfaces 276 of the first ribs 218 and interacting surfaces 278 of the triangular flanges 223 of the end ribs 221 and the bottom piece 230 incorporated the recesses 282 on the engagement surfaces 243, 245 of the triangular gussets 242 and end gussets 244. The enclosure and cover were injection molded from HDPE with calcium carbonate powder as an additive. Neither the cover nor the enclosure included any structural support member made of metal, wood, concrete, polymer concrete, or other material having strength greater than the HDPE. The testing was completed by Applied Testing and Geosciences, LLC, a third party testing company.

The enclosure assembly 100 of the Examples was found to conform to the requirements of the Tier 22 Specification for underground enclosures in ANSI/SCTE 77 (2023), including the requirements to withstand greater than or equal to 2,400 pounds of force in the lateral sidewall test using the test methods specified in ANSI/SCTE 77.1 (2023), withstand greater than or equal to 22,500 pounds of force in the vertical sidewall test using the test methods specified in ANSI/SCTE 77.2 (2023), and withstand greater than or equal to 22,500 pounds of force in the vertical cover test using the test methods specified in ANSI/SCTE 77.3 (2023). The test data is provided in Tables 1-3.

TABLE 1
Results of Lateral Sidewall (LS) Test

| | | | | | Conform/ |
|---|---|---|---|---|---|
| Test | | | | | Not |
| Method | Description | Spec | Result | Units | Conform |
| ANSI 77.1 | LS Testing Tier | Tier 15 | Tier 15 | N/A | C |
| | | and 22 | and 22 | | |
| ANSI 77.1 | LS - Design Load | ≥2,400 | 2,400 | lb_{f} | C |
| | (10 cycles) | | | | |
| ANSI 77.1 | LS - Max | ≤0.656 | 0.429 | inches | C |
| | Displacement at | | | | |
| | Design Load | | | | |
| ANSI 77.1 | LS - Test Load | >3,600 | >3,600 | lb_{f} | C |

TABLE 2
Results of Vertical Sidewall (VS) Test

| | | | | | Conform/ |
|---|---|---|---|---|---|
| Test | | | | | Not |
| Method | Description | Spec | Result | Units | Conform |
| ANSI 77.2 | VS Testing Tier | Tier 22 | Tier 22 | N/A | C |
| ANSI 77.2 | VS - Design Load | ≥22,500 | 22,500 | lb_{f} | C |
| | (10 cycles) | | | | |
| ANSI 77.2 | VS - Max Vertical | ≤0.5 | 0.444 | inches | C |
| | Displacement at | | | | |
| | Design Load | | | | |
| ANSI 77.2 | VS - Test Load | ≥33,750 | 33,750 | lb_{f} | C |

TABLE 3
Results of Vertical Cover (VC) Test for the full cover

| | | | | | Conform/ |
|---|---|---|---|---|---|
| Test | | | | | Not |
| Method | Description | Spec | Result | Units | Conform |
| ANSI 77.2 | VC Testing Tier | Tier 22 | Tier 22 | N/A | C |
| | (full cover) | | | | |
| ANSI 77.2 | VC - Design Load | ≥22,500 | 22,500 | lb_{f} | C |
| | (10 cycles) Full Cover | | | | |
| ANSI 77.2 | VS - Max Vertical | ≤0.5 | 0.389 | inches | C |
| | Disp. at Design Load | | | | |
| | (Full Cover) | | | | |
| ANSI 77.2 | VS - Test Load | ≥33,750 | 33,750 | lb_{f} | C |
| | (Full Cover) | | | | |

As shown in Table 1, the enclosure assembly conformed to the requirements of Tier 22 for the lateral sidewall test by withstanding at least 2,400 lb_{f} and having a displacement less than 0.656 inches at the test load of 2,400 lb_{f}. The test load for the lateral sidewall test was increased to 3,600 lb_{f}, and the enclosure assembly withstood the load of 3,600 lb_{f} without failure. Thus, the enclosure assembly was found to meet and exceed the requirements under the Tier 22 standard for the lateral sidewall test.

As shown in Table 2, the enclosure assembly conformed to the requirements of Tier 22 for the vertical sidewall test by withstanding at least 22,500 lb_{f} and having a displacement less than 0.5 inches at the test load of 22,500 lb_{f}. The test load for the vertical sidewall test was increased to 33,750 lb_{f}, and the enclosure assembly withstood the load of 33,750 lb_{f} without failure. Thus, the enclosure assembly was found to meet and exceed the requirements under the Tier 22 standard for the vertical sidewall test.

As shown in Table 3, the enclosure assembly conformed to the requirements of Tier 22 for the vertical cover test (with the full cover) by withstanding at least 22,500 lb_{f} and having a displacement less than 0.5 inches at the test load of 22,500 lb_{f}. The test load for the vertical cover test (full cover) was increased to 33,750 lb_{f}, and the enclosure assembly withstood the load of 33,750 lb_{f} in the vertical cover test without failure. Thus, the enclosure assembly was found to meet and exceed the requirements under the Tier 22 standard for the vertical cover test. These results were achieved by the enclosure and cover without any additional rigid support structures made from materials other than the polymer composition comprising the HDPE and calcium carbonate and without using any reinforcing fibers (e.g., carbon fibers, fiberglass, SiC fibers, or other reinforcing fibers) in the polymer composition.

While various embodiments of the utility enclosure and cover have been described herein, it should be understood that it is contemplated that each of these embodiments and techniques may be used separately or in conjunction with one or more embodiments and techniques. It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A utility enclosure assembly comprising an enclosure and a cover, wherein:
the utility enclosure assembly is configured to be installed underground with a top surface of the cover proximate grade level;
the enclosure comprises an inner surface having a ledge proximate a top of the enclosure;
the ledge supports the cover when the cover is engaged with the enclosure;
the enclosure and the cover are constructed of high-density polyethylene and optionally calcium carbonate; and
the utility enclosure assembly is compliant with the Tier 22 requirements for underground utility enclosures, as determined according to the standard test methods in ANSI/SCTE 77 (2023).

2. The utility enclosure assembly of claim 1, wherein the cover comprises a top piece and a bottom piece.

3. The utility enclosure assembly of claim 2, wherein:
the top piece comprises a plurality of first ribs extending from a bottom surface of the top piece;
each of the plurality of first ribs have an angled interaction surface at each end;
the bottom piece comprises a plurality of triangular gussets extending from a top surface of the bottom piece;
each of the triangular gussets have an angled engagement surface complimentary to and aligned with one of the angled interaction surfaces of the plurality of first ribs; and
when the top piece and the bottom piece are assembled together to form the cover, the interaction surfaces of the plurality of first ribs engage with the engagement surfaces of the plurality of triangular gussets to redirect the downward forces outward towards a sidewall of the cover.

4. The utility enclosure assembly of claim 3, wherein:
one of the interaction surfaces of the first ribs or the engagement surfaces of the triangular gussets comprise a plurality of teeth extending outward;
the other one of the interaction surfaces of the first ribs or the engagement surfaces of the triangular gussets comprise a plurality of recesses;
when the interaction surfaces of the first ribs are engaged with the engagement surfaces of the triangular gussets, the plurality of teeth are received in the plurality of recesses; and
engagement of the plurality of teeth with the plurality of recesses maintains engagement of the interaction surfaces of the first ribs with the engagement surfaces of the triangular gussets.

5. The utility enclosure assembly of claim 3, wherein the bottom piece comprises:
the sidewall of the cover; and
a plurality of third ribs extending from a top surface of the bottom piece, wherein:
the plurality of third ribs extend a width of the bottom piece from the sidewall a first side of the bottom piece to the sidewall on a second side of the bottom piece;
each of the plurality of third ribs is coupled to the sidewall on both ends; and
the plurality of third ribs hold the sidewalls in place to reduce or prevent outward bowing of the sidewalls.

6. The utility enclosure assembly of claim 5, wherein:
the top piece further comprises a plurality of second ribs, where the plurality of second ribs stiffen a middle of the top piece of the cover; and
the bottom piece further comprises a plurality of fourth ribs extending from the upper surface of the bottom piece, wherein the plurality of fourth ribs stiffen a middle of the bottom piece of the cover.

7. The utility enclosure assembly of claim 2, wherein the top piece and the bottom piece are attached together with one or more fasteners, welds, adhesives, interlocking tabs, heat stake welds, or combinations thereof.

8. The utility enclosure assembly of claim 1, further comprising one or a plurality of name ID pucks attachable to a top surface of the cover, wherein:
the name ID pucks comprise a replaceable lift pin, a name plate, and a plurality of rigid tabs;
the cover comprises a puck attachment fitting comprising a plurality of arcuate openings and two resilience tabs; and
the name ID puck is installed and locked in place in the puck attachment fitting.

9. The utility enclosure assembly of claim 1, wherein the enclosure comprises one or a plurality of foot pockets configured to enable ingress and egress from the enclosure from above grade.

10. The utility enclosure assembly of claim 1, wherein the utility enclosure assembly withstands a vertical load on the cover of at least 22,500 pounds of force without failing, as determined according to the cover vertical load test in ANSI/SCTE 77.3 (2023).

11. The utility enclosure assembly of claim 1, wherein the utility enclosure assembly withstands a vertical sidewall load of at least about 22,500 pounds of force, as determined according to the box vertical sidewall test for boxes less than 60″ long in ANSI/SCTE 77.2 (2023).

12. The utility enclosure assembly of claim 1, wherein the utility enclosure assembly withstands a lateral load of at least about 2,400 pounds of force, as determined according to the box lateral sidewall test for boxes less than 60″ long in ANSI/SCTE 77.1 2023.

13. The utility enclosure assembly of claim 1, wherein the enclosure, the cover, or both consist of HDPE, optionally calcium carbonate, and optionally one or more additive selected from the group consisting of pigments, colorants, UV inhibitors, processing aids, and any combination thereof, wherein the processing aids are selected from the group consisting of lubricants, rheology modifiers, blowing agents, and combinations thereof.

14. The utility enclosure assembly of claim 1, further comprising at least one attachment mechanism configured to attach the cover to the enclosure, wherein the at least one attachment mechanism comprises a nut plate and an attachment bolt.

15. The utility enclosure assembly of claim 14, wherein:
the attachment bolt is a captive bolt comprising a head, a shank, a relief region, and a threaded region;
the relief region is positioned between the shank and the threaded region and has an outer diameter less than an outer diameter of the shank and the threaded region;
the relief region maintains the attachment bolt in engagement with the cover when the attachment bolt is unthreaded from the nut plate.

16. A cover for an underground utility enclosure, the cover comprising a top piece and a bottom piece, wherein:
the top piece has a plurality of first ribs and the bottom piece has a plurality of triangular gussets; and
when the top piece and the bottom piece are assembled together to form the cover, the plurality of first ribs engage with the plurality of triangular gussets to redirect a portion of downward forces exerted on the cover outward towards a sidewall of the cover.

17. The cover of claim 16, wherein:
the plurality of first ribs extend downward from a bottom surface of the top piece;
each of the plurality of first ribs have an angled interaction surface at each end;
the plurality of triangular gussets extending upward from a top surface of the bottom piece;
each of the triangular gussets have an angled engagement surface complimentary to and aligned with one of the angled interaction surfaces of the plurality of first ribs; and
when the top piece and the bottom piece are assembled together to form the cover, the interaction surfaces of the plurality of first ribs engage with the engagement surfaces of the plurality of triangular gussets to redirect the portion of the downward forces outward towards the sidewall of the cover.

18. The cover of claim 16, wherein:
the plurality of first ribs have interaction surfaces at each end;
the plurality of triangular gussets each have an engagement surface complimentary to and aligned with one of the interaction surfaces of the first ribs; and
when the top piece and the bottom piece are assembled together to form the cover, the interaction surfaces of the first ribs engage the engagement surfaces of the triangular gussets, wherein the engagement redirects the at least a portion of the downward forces exerted on the top piece of the cover horizontally outward toward the sidewall of the cover.

19. The cover of claim 18, wherein:
one of either the interaction surfaces of the first ribs or the engagement surfaces of the triangular gussets comprise a plurality of teeth extending outward;
the other one of either the interaction surfaces of the first ribs or the engagement surfaces of the triangular gussets comprise a plurality of recesses;
when the interaction surfaces of the first ribs are engaged with the engagement surfaces of the triangular gussets, the plurality of teeth are received in the plurality of recesses; and
engagement of the plurality of teeth with the plurality of recesses maintains engagement of the interaction surfaces of the first ribs with the engagement surfaces of the triangular gussets.

20. The cover of claim 16, wherein the top piece further comprises a plurality of second ribs, where the plurality of second ribs stiffen a middle of the top piece of the cover.

21. The cover of claim 16, wherein the bottom piece comprises:
the sidewall of the cover; and
a plurality of third ribs extending from a top surface of the bottom piece, wherein:
the plurality of third ribs extend a width of the bottom piece from the sidewall a first side of the bottom piece to the sidewall on a second side of the bottom piece;
each of the plurality of third ribs is coupled to the sidewall on both ends; and
the plurality of third ribs hold the sidewalls in place to reduce or prevent outward bowing of the sidewalls.

22. A utility enclosure assembly comprising an enclosure and a cover, wherein:
the utility enclosure assembly is configured to be installed underground with a top surface of the cover proximate grade level;
the enclosure comprises an inner surface having a ledge proximate a top of the enclosure;
the ledge supports the cover when the cover is engaged with the enclosure; and
the inner surface of the enclosure comprises one or a plurality of foot pockets configured to enable egress from the enclosure.

23. A utility enclosure assembly comprising an enclosure, a cover, and an attachment mechanism, wherein:
the utility enclosure assembly is configured to be installed underground with a top surface of the cover proximate grade level;
the enclosure comprises an inner surface having a ledge proximate a top of the enclosure;
the ledge supports the cover when the cover is engaged with the enclosure;
the attachment mechanism comprises an attachment bolt;
engagement of the attachment bolt with the cover and the enclosure securely attaches the cover to the enclosure; and
the attachment bolt is a captive bolt configured to maintain engagement with the cover when the captive bolt is disengaged from the enclosure.

24. A utility enclosure assembly comprising an enclosure, a cover, and a name ID puck attachable to a top surface of the cover, wherein:
the utility enclosure assembly is configured to be installed underground with a top surface of the cover proximate grade level;
the enclosure comprises an inner surface having a ledge proximate a top of the enclosure;
the ledge supports the cover when the cover is engaged with the enclosure;
the name ID pucks comprises a replaceable lift pin, a name plate, and a plurality of rigid tabs;
the cover comprises a puck attachment fitting comprising a plurality of arcuate openings and a plurality of resilient tabs; and
the name ID puck is removably attached to the cover via the puck attachment fitting.
